(19) United States
(12) Patent Application Publication
(10) Pub. No.: US 2007/0050770 A1
(43) Pub. Date: Mar. 1, 2007

(54) Method and apparatus for uniformly integrating operating system resources

(76) Inventor: Nile Josiah Geisinger, Petaluma, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/216,432

(22) Filed: Aug. 30, 2005

(51) Int. Cl. G06F 9/46

(52) U.S. Cl. 718/100

(57) ABSTRACT

Method and apparatus for uniformly integrating operating system resources are described herein. In one embodiment, an example of a computing system includes, but is not limited to, a first operating system with a first operating system kernel and a first operating system resource, a second operating system with a second operating system kernel and a second operating system resource, and a resource translator to create a uniform representation of the first and second operating system resources as at least one operating system resource in a third operating system. Other methods and apparatuses are also described.

### RELATED APPLICATIONS

This application is related to the following applications:
Co-pending U.S. patent application Ser. No. ______, entitled “Computing Platform Having Transparent Access To Resources Of A Host Platform”, filed Aug. 30, 2005.
Co-pending U.S. patent application Ser. No. ______, entitled “Method and Apparatus for Providing Cross-Platform Hardware Support For Computer Platforms”, filed Aug. 30, 2005.
Co-pending U.S. patent application Ser. No. ______, entitled “Software Executables Having Virtual Hardware, Operating Systems, and Networks”, filed Aug. 30, 2005.
Co-pending U.S. patent application Ser. No. ______, entitled “Programming Language Abstractions for Creating and Controlling Virtual Computers, Operating Systems and Networks”, filed Aug. 30, 2005.

The above-identified applications have been assigned to a common assignee of this application and are incorporated by reference herein.

### FIELD OF THE INVENTION

The present invention relates generally to a data processing system. More particularly, this invention relates to uniformly integrating operating system resources.

### BACKGROUND

The history of computer software is a history of the evolution of the abstractions that enable users to communicate with the underlying hardware. These abstractions have allowed both users and programmers to take advantage of the ever-increasing power of computer hardware and the ever-growing body of computer code. A computer's hardware together with the collection of abstractions that make up the operating system that resides on it are known as the “platform” upon which programmers develop and users run software. The development of computer platforms has evolved through several distinct phases, each introducing new layers of abstraction between the user and the hardware. Each of these phases has increased either the complexity or the portability of the applications that can be written for these platforms. Milestones in this evolution are the single application machine, the operating system, the virtual machine, and the virtual operating system.

Single Purpose Computers

The first computing platform was a computer that could only run one program at a time. In the early days of computing the computer was essentially a physical instantiation of the program it ran. A program would be physically configured into the design of the computer through the wiring of the machine. It quickly became clear that a more flexible and less labor-intensive method for implementing specific programs on computers was desirable. The separation of the CPU and physical memory enabled the development of machine code which led to the development of early programming languages. This made it possible to write a program in a programming language which could then be loaded onto a computer's physical memory and executed by the computer at start-up. This first abstraction changed the practice of programming computers from the physical activity of configuring the computer to the digital activity of writing code.

Operating Systems

At this point, a method that allowed for the execution of multiple programs at the same time became desirable. This led to the invention of operating systems. Operating systems provided a new set of abstractions between the computer hardware and its software. These abstractions included file systems, process tables, and memory management which collectively enabled applications to be accessed easily on the computer and also to appear to run at the same time. The file system provides a naming scheme for the disk space where different programs and data can be stored. The process table allows the computer's processor to switch back and forth among execution of different programs, giving the illusion of simultaneous execution. It accomplishes this by storing information about a paused process in memory and loading that information from memory when the process' execution is resumed. Memory management makes it possible for the computer to load a program into a specific section of memory and to prevent other programs from using that section of memory. The result is that each program runs intermittently in a managed way, as if it were the only program using the CPU and its related hardware. As operating systems have evolved, new abstractions have also been introduced that make it possible for multiple programs to work in concert with each other through network ports, pipes, shared files and other communication channels.

Taking advantage of these advancements, a variety of different hardware and software manufacturers began to develop their own incompatible operating systems that included incompatible Application Programming Interfaces (APIs). Because libraries and the APIs they expose are operating system specific, traditional applications are dependent on the particular APIs of the operating system for which they are written and are therefore not portable. In addition, when programs are compiled, they are translated to the instruction set used by the particular CPU type underlying the operating system in question and can thereafter only be executed on that type of CPU. The result is that programs written in traditional low-level languages can usually only run on the operating system and hardware for which they were compiled. A C++ program that is compiled for a Solaris operating system on a Sparc CPU cannot run on any other combination of operating system and CPU without additional help. A different operating system would not include the Solaris libraries that the application depends upon. A different CPU will not be able to execute the application's Sparc machine code.

The consequence of these limitations is that programs have historically been dependent on the specifics of the underlying platform. As a result, vast bodies of code have been produced that can only be run on specific combinations of hardware and operating systems. This problem was solved by the development of the virtual CPU and the cross-platform library.

Virtual CPUs

The language that a compiled application uses to communicate with a CPU is known as an instruction set. A virtual CPU exposes an instruction set to applications, just like a physical CPU. A virtual CPU may emulate the instruction set of existing hardware like x86, SPARC or IBM's System/360. Alternatively, it may expose an instruction set unlike that of an existing physical CPU. An application compiled for the instruction set of a virtual CPU executes its bytecode on the virtual rather than on the physical CPU. Because a virtual CPU is essentially software, it can be ported to run on multiple combinations of hardware and operating systems.

Cross-Platform Libraries

A cross-platform library provides a uniform set of APIs across multiple operating systems. A cross-platform library calls the specific APIs of the operating system that it is installed on to access its resources while presenting the same uniform APIs to all applications that use it. One type of cross-platform library is a high-level widget library that utilizes the high-level APIs of the supported operating systems to create cross-platform versions of the high-level classes frequently used by software developers. As an example, most programming libraries that support GUI development provide a GUI element known as a checkbox. Different Objective C and C++ checkbox classes exist in the APIs of a variety of different operating systems. Each checkbox class provides very similar functionality, but is accessed through different library calls. Instead of requiring programmers to write a different version of code to access the native checkbox classes of each operating system, a cross-platform widget library allows programmers to access these classes through a single uniform set of library calls for all operating systems. It, in turn, then calls the operating system specific checkbox APIs. Another approach that some cross-platform libraries use is to call the lower-level APIs of the system to create more precise widgets. When this approach is used, all of the components of the checkbox are “painted” by a toolkit using low-level APIs to create a checkbox that has the look and feel of a native checkbox for the operating system. Both manners of writing cross-platform libraries allow developers to write only one version of code that can be compiled and run on a multitude of computer platforms.

Born from a merger of cross-platform libraries and virtual machines, application virtual machine platforms are used as uniform development platforms and run-time environments to allow portable development and execution of applications. This type of virtual machine platform consists of a virtual CPU coupled with host-specific cross-platform libraries. This technology makes it possible to write applications and compile them into binaries that can run on any operating system while dynamically using host system resources to provide users with the native look and feel of the underlying platform. Unlike traditional applications that run on the physical CPU, the bytecode of virtual machine applications runs on the virtual CPU. Unlike traditional applications that are written to APIs specific to the underlying host operating system (also simply referred to as host) these portable applications are written to the uniform APIs of a cross-platform library. By using both a virtual machine and a cross-platform library, developers can produce from a single code base a single, portable executable that can run on a number of platforms. The Internet has made such portable execution highly desirable and as a result the research and use of virtual machines has increased dramatically over the past decade.

As virtual machines have become widely adopted, their limitations have become more apparent. The greatest drawback to virtual machines is that they limit programmers to the small set of higher-level programming languages that run on the virtual machine. As a result, programmers that use virtual machines to create portable applications are unable to utilize the vast body of code written in traditional low-level languages like C and C++ since that codebase is traditionally dependent on specific operating system APIs and on specific physical CPU types. In addition, it is often desirable for programs written in a higher-level virtual machine language to interact with applications written in a different language. It may be desirable, for instance, to use a database written in a low-level language like C to store information used by applications that run on a virtual machine. Software solutions that involve multiple codebases using multiple machines (real or virtual) are extremely difficult to integrate and distribute as a single binary. While virtual machines allow limited portable execution, they cannot run traditionally run binaries compiled from low-level programming languages, nor can they execute compound executables that integrate machine code and bytecode from multiple virtual machines and virtual operating systems.

Virtual Operating Systems

The next stage in the evolution of computer platforms is the virtual operating system. Virtual operating systems, have taken a different approach to the platform incompatibility problem. Virtual operating systems are most commonly used for running legacy applications on newer operating systems and for testing applications on a variety of platforms. Currently there are several approaches to virtualizing operating systems.

An application-level virtual operating system provides a sophisticated application running on a host operating system that emulates a set of guest operating system (also simply referred to as guest) resources. Applications compiled to a library that accesses these simulated resources appear as if they are running on the guest operating system. Because this kind of virtual operating system is compiled as an application and does not include a virtual CPU, software that runs on it is conventionally compiled to machine code that is compatible with the underlying physical CPU.

Virtual private servers (VPS) provide an extension to the kernel of the host operating system that enables the user to partition the kernel and the core services it provides into separate distinct units. Each VPS does not have its own kernel, but consists of partitioned resources from the common kernel that it shares with other Virtual Private Servers. Each VPS acts like an independent virtual operating system with respect to its core resources and the processes that run on top of it. In this way several distributions of the same type of operating system can each be installed on a VPS and be run simultaneously on a single, shared kernel. Although the guest operating systems share the underlying hardware, they are effectively isolated from each other and visible only to their own applications. The core limitation is that the guests must be closely related to each other by virtue of their shared kernel.

Another type of virtual operating system relies on a hypervisor, also known as a Virtual Machine Monitor (VMM). The hypervisor divides the hardware resources and apportions them to the guest operating systems. Conventionally, the user can install different full-fledged operating systems on the apportioned hardware resources as long as each of these systems is compatible with the physical CPU and the associated apportioned hardware. Hypervisor virtualization allows more heterogeneity than virtual private server virtualization in that the guest operating systems may have different types of kernels.

System emulators are virtual operating systems that run on emulated hardware that itself runs as an application on a host operating system. With system emulators, guest operating systems are capable of emulating all of the features of a full-fledged computing platform including a physical CPU if necessary. In the case that the guest operating system requires the same type of CPU as the host operating system, the guest may share the physical CPU rather than emulating it. Because the hardware expected by the guest operating system may either be emulated or actually available, system emulator virtualization allows programs compiled to a system emulator to be truly cross-platform. This includes programs written in low level languages like assembly, C, or C++.

While system emulator-type virtual operating systems allow applications written for a number of operating systems to run on a single computer, current solutions fail to provide cross-platform access to host resources. This prevents the virtual operating system from being transparent to the user because applications that run on the virtual operating system fail to fully adapt the resources of the host operating system. Applications running on a conventional virtual operating system look like applications native to the guest operating system not like those native to the host because they use the graphics libraries of the guest operating system rather than those of the host. In addition, the user must install and run a given application on the appropriate guest operating system requiring some knowledge of the various available operating systems and applications. This is because currently available solutions lack a dispatching mechanism that automatically installs a package or runs an application on the appropriate resident operating system or virtual machine.

Integation of Security Policies

The security and protection of the host operating system has been a much studied aspect of virtual machines and operating systems. Most implementations of virtual machines and operating systems make “sandboxes” for themselves in order to isolate them from their hosts. These sandboxes consist of security policies that prevent applications running on the virtual machine from accessing host resources, except as necessary.

Another limitation of current platforms using multiple virtual operating systems and virtual machines is that they lack a consistent, universal mechanism to integrate the variety of security policies associated with such a complex system. The existing local solutions work well for simple systems including only one virtual machine. A programmer deploying programs that run on multiple virtual machines and virtual operating systems traditionally specifies a unique security policy for each virtual machine and virtual operating system. There is a growing need for a system that provides a single security specification which is dynamically adapted to the specific security technologies of different virtual machines and virtual operating systems. There is also a need for a security policy that can simultaneously provide protection for lower-level programming languages as well as higher-level languages which use interpreters and virtual machines.

Software Packaging and Distribution

Several technologies enable the distribution of complex software solutions. These solutions include the distribution of software components, the use of packages in package management systems, and cross-platform binaries that have been compiled to virtual machines.

Types in Programming Languages

Recent advances in programming languages have increased the user's ability to create and use newly defined programming language types. These advances include the inclusion of XML data types and embedded SQL syntax in several programming languages.

With the use of virtual operating system platforms, virtual operating systems and the virtual hardware they use become commodities that can be created, installed, used and uninstalled programmatically. Since the user can dynamically create virtual computers, operating systems, networks, file systems and other virtual components, these abstractions can become native data types within the programming languages used on these new platforms. To take full advantage of these newly dynamic components, programmers need new data types and APIs. Although some virtual operating system platforms are managed by programs and libraries that allow this functionality, there is no existing system or method that enables developers to access this capability from within the languages used to write applications that run on the virtual operating systems themselves. This limitation hampers the ability of cross-platform developers to write cross-platform applications that dynamically instantiate virtual hardware and virtual operating systems.

Integration of System Resources

When differing types of operating systems are connected either through virtualization or in the context of a network or a distributed system it becomes desirable to provide access to the resources of one operating system through the interface of a different operating system. In order to do this, the underlying resources of the various connected operating systems must be integrated in some way. Technologies that connect operating systems as well as simple forms of resource integration have existed for decades. Some of the conventional technologies used to integrate resources are described below.

The state of the art has made some advances in the integration of resources, mainly in the context of distributed and networked computers. Nonetheless, the mechanisms through which users and applications access hardware resources are operating system specific and often require operating system specific code. Developers facing the task of porting their applications to several different operating systems need the resources of each operating system to be presented through a uniform interface, not just an integrated interface. Such uniformity would allow developers to write software for different platforms with only one platform-independent version of source code. The state of the art does not yet provide uniform (as opposed to unified) views of the resources of multiple underlying systems. The need for a uniform environment is as critical as the need for the uniform CPU and APIs provided by modern virtual machines.

File System Unification

Solutions that unify file systems are almost as old as operating systems themselves. One widely used approach allows a computer to access files that exist on other computers on a network as if these files were on a local disk. More sophisticated solutions unify the different representation of a particular resource on the disparate nodes of a distributed file system. Systems also exist that virtualize the file systems and processes of computers attached to a network so that they may be administered in a cohesive way, as if they were a single computer. Some existing technologies take this one step further by unifying the resources of virtual machines as well as network nodes. One high-level programming language uses file system features common to several operating systems through the use of an abstract file system description to generate file system code that can be compiled for multiple platforms. A further solution provides a stackable unified file system that allows file systems to be merged into a single logical view that matches the structure of a chosen set of file systems.

Virtual operating system technologies have adapted many of these approaches. One protocol allows users and programs to define and access all aspects of local and remote, physical and virtual resources. Using this approach, any resources can be represented as files within a hierarchical file system. Each application runs within its own namespace, giving it a private view of the resources and services it needs to access. Such namespaces are represented as a hierarchy of files, are accessible via standard file access operations, and may include resources from multiple computers within the network.

Other approaches enable basic access to the resources of one operating system by another and allow multiple operating systems to be cohesively administered as if they were one. In addition, virtual and distributed operating system technologies have focused on file system transparency. One such technology enables a virtual operating system to use a directory on the file system of the host as a mounted file system in the virtual operating system. A similar technology provides transparent access to the file system of the operating system on which it is running. Other virtual operating system technologies allow access to files on the host operating system through the use of file sharing technologies that were developed to allow combined namespaces within distributed file systems.

A number of approaches exist that allow virtual machines transparent access to the host operating system, but these approaches do not address the fact that files are referenced using different formats and using different paths on different operating systems. For instance, user files on Linux, Macintosh and Windows operating systems are found in different locations within their respective file systems, and these file systems themselves use different formatting conventions. The result is that a program written to change files in a user's home directory on one operating system will not work on another operating system since these files will be in a different location.

Network and Process Unification

Network unification approaches primarily focus on unifying services to create redundancy in the events of failures. The primary need of a cross-platform developer, however, is for a uniform representation of networking primitives, not a unification of the resources on a network. Cross-platform APIs are a step in this direction because they do provide one method for managing network connections on different operating systems in a uniform manner. Cross-platform networking libraries, for example, are extremely popular because they provide high-level abstractions of networking operations on different operating systems. With them, it is possible to create programs that open sockets, start up services, and connect to other computers using a number of protocols.

The rise of web services has created a need for reliable network services. One of the most popular approaches to meeting this need is to unify the resources in a network to create redundant services or some form of load-balancing. One approach is seen in an advanced load balancing solution for systems with a scalable server built on a cluster of real servers. This system allows several computers in a network to act as if they were one. If one node in the network that is performing a service fails another node will take over the work of the failed node. In alternative setups, one computer can distribute requests to other computers in the network using a scheduling algorithm. Due to the popularity of web services, there are several different approaches for load-balancing solutions and a significant amount of research has been devoted to the problem.

Unification of High-Level Resources

There is also a shortage of solutions that allow uniform representations of operating system resources besides file systems including processes, interprocess communication, and network communication. Nor do current solutions provide a useful uniform representation of user and group data, system configuration, application installation management, or ontological systems. This is a significant limitation since cross-platform developers benefit from having a uniform representation of higher level resources of the different operating systems for which they are developing.

There are several approaches that support the uniform management of high-level resources of multiple operating systems. Users must either work through a GUI or through the use of cross-platform libraries. With respect to system and program configuration, developers use cross-platform libraries to simplify the management of multiple systems. One example of such a set of libraries is a web-based system administration tool that uses web browsers to manage user accounts, web servers, DNS, file sharing and so on. This approach includes a simple web server and a number of CGI programs which directly update system files. The APIs of the host operating system are used via cross-platform libraries to manage resources of multiple operating systems. With regards to package management, developers often use cross-platform package solutions to create packages that can be installed on multiple operating systems.

While solutions do exist that provide a uniform set of APIs for accessing and changing resources on different operating systems, no currently available virtual operating system uniformly represents the higher-level resources of the host as if they were native to the guest.

Ontologies

Ontologies are systems or conceptual schemes that specify elements and their relationships with respect to a certain domain. Ontologies are primarily used in the field of artificial intelligence and logic programming. The elements they include normally have a range of possible relationships to the other elements in the ontology. These relationships may be abstract like the relationship between inheritance and composition, or concrete like “owned by” or “is a function of”. This type of ontological system is conventionally associated with a logic programming language that allows programmers to draw conclusions that are not explicitly represented in the ontological system, but which may be logically inferred from the definitions and relationships of the ontological elements in the system.

Some modern operating systems plan to include ontological systems in addition to standard operating system resources. Historically, logical programming technologies facilitate automatic problem solving through complex examinations of ontologies. Since the advent of XML, modern technologies have made extensive use of ontologies. Currently under development is an ontological file system that enables programmers to define types and their relationships using XML. This system allows the programmatic examination of these types and relationships using APIs of the associated virtual machine platform. Another example is the family of semantic web specifications sponsored and maintained by the World Wide Web Consortium (W3C). This system identifies resources using uniform resource identifiers (URI) which can have properties and relationships with other resources through the use of statements in the form of subject-predicate-object expressions which are expressed in an XML format. There are several technologies that support semantic programming and the programmatic examination of ontologies. All of these ontologies are examples of a further type of high-level operating system resources.

Cross-Platform Device Drivers

Device drivers are the modules of an operating system that control the hardware of a computer. Sound cards, video cards, USB devices and other hardware all require device drivers. On modern operating systems, device drivers are components of the kernel, and they rely on operating-system specific kernel libraries to communicate with hardware. The most popular approach for creating cross-platform device drivers is to create a cross-platform API that communicates with the device libraries of a number of different operating systems.

An alternative approach is through the use of a hypervisor. A hypervisor is a minimal operating system on a computer that partitions and virtualizes the physical devices on a computer so that more than one operating system can run on it simultaneously. Instead of providing virtual representations of the exact hardware that is running on the computer, a hypervisor has the ability to present a uniform set of virtual devices regardless of the underlying hardware. This means an operating system that runs on top of the hypervisor does not need to recognize a wide variety of network cards, for instance, but only the generic one presented by the hypervisor. The primary limitation of this approach is that it is does not work for non-hypervisor virtualization methods.

Traditional virtual devices rely on an interface or library between the device driver of the host and its corresponding physical device. This type of virtual device is therefore unable to offer any functionality beyond that of the host device driver, even if the guest operating system has a more capable native device driver. Furthermore, if there is no appropriate device driver on the host, the virtual device is unable to access the hardware. Missing from the state of the art is a system for providing missing or insufficient hardware device drivers via a virtual operating system.

In conclusion, the current solutions have numerous limitations in the areas of native look and feel, integrated security, advanced programming types, programming language support, uniform access to system resources and cross-platform hardware support.

### SUMMARY OF THE DESCRIPTION

Method and apparatus for uniformly integrating operating system resources are described herein. In one embodiment, an example of a computing system includes, but is not limited to, a first operating system with a first operating system kernel and a first operating system resource, a second operating system with a second operating system kernel and a second operating system resource, and a resource translator to create a uniform representation of the first and second operating system resources as at least one operating system resource in a third operating system.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 depicts a common architecture of a conventional computer platform including an operating system and its main components.

FIG. 2 depicts cross-platform libraries allowing one version of source code to be compiled for different operating systems.

FIG. 3 depicts a conventional use of development platform virtual machines for cross-platform execution of bytecode applications.

FIG. 4 depicts a conventional virtual operating system installed on a host platform.

FIG. 5 is a functional diagram showing how an application running on a conventional virtual operating system and an application running on the host operating system access the available software and hardware resources at run-time.

FIG. 6 depicts a block diagram of computing architecture according to one embodiment of the invention.

FIG. 7 shows an embodiment of the invention in which the virtual operating system runs like an application on the host, without any hardware emulation.

FIG. 8 shows an embodiment of the invention in which the virtual operating system is part of a virtual private server system.

FIG. 9 shows an embodiment of the invention in which the virtual operating system utilizes a hypervisor.

FIG. 10 shows an embodiment of the invention in which the virtual operating system runs like an application on the host and includes hardware emulation.

FIG. 11 is a functional diagram showing how an application running on an embodiment of the invention accesses the resources of the virtual operating system and the host operating system at run-time.

FIG. 12 shows an embodiment of the invention in which code is dynamically compiled to run natively on the host, while the resources of the virtual operating system are accessed via a reverse dispatch library.

FIG. 13 depicts an embodiment of the communication channel between guest and host.

FIG. 14 depicts an embodiment of the invention including an integrated virtual security system.

FIG. 15 depicts an embodiment of the invention executing a simple application bundled into a compound executable.

FIG. 16 depicts an embodiment of the invention with a run-time dispatcher executing a compound executable for various platforms.

FIG. 17 depicts an embodiment of the invention preparing to execute a compound executable.

FIG. 18 depicts the system of FIG. 17 after the new virtual operating system has been booted.

FIG. 19 depicts an embodiment of the invention executing an application wrapped as a software component for use by another application.

FIG. 20 depicts an embodiment of the invention including specialized libraries for new high-level programming language features.

FIG. 21a displays a Python code sample incorporating new programming language data types.

FIG. 21b displays a Perl code sample incorporating new programming language data types.

FIG. 22 depicts an embodiment of the invention including a generic uniform resource.

FIG. 23 depicts an embodiment of the invention including a uniform virtual file system.

FIG. 24 depicts an embodiment the invention including a uniform virtual process manager.

FIG. 25a details a code sample representing one implementation of a uniform virtual process manager.

FIG. 25b shows a view of some fields of the uniform unified virtual process table resulting from this implementation.

FIG. 25c shows a view of some fields of the host process table from which this unified process table is derived.

FIG. 26 depicts an embodiment of the invention including a uniform virtual process communication system.

FIG. 27 depicts an embodiment of the invention including uniform virtual networking.

FIG. 28 depicts an embodiment of the invention including a uniform virtual user and group management system.

FIG. 29 depicts an embodiment of the invention having a uniform virtual application installation manager.

FIG. 30 depicts the invention including a uniform virtual system configuration manager.

FIG. 31 depicts an embodiment of the invention including a uniform virtual ontology system.

FIG. 32 depicts a conventional method of implementing device drivers on a virtual operating system.

FIG. 33 depicts a method for implementing device drivers on a virtual operating system using a hypervisor.

FIG. 34 depicts a system for accessing hardware devices from a virtual operating system through a translation layer, according to one embodiment of the invention.

FIG. 35 is a block diagram illustrating an example of a data processing system which may be used with an embodiment of the invention.

### DETAILED DESCRIPTION

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

An embodiment of the invention improves on the software abstractions available to developers and users. It continues the ongoing evolution of computer platforms by creating a transparent uniform virtual computer platform that can reside on top of a wide variety of existing platforms. According to one embodiment, the libraries resident on both the virtual platform and the underlying host are directly linked so that they present a single platform to virtual operating system applications. This allows applications to transparently use the resources of both the host operating system and the virtual operating system.

In one embodiment, a new type of computer platform is constructed by putting together virtual operating systems and virtual machines in a novel way. In a particular embodiment, this is done using implementation-specific cross-platform libraries, a dispatcher mechanism, a communication channel and unified security protocols along with other subsystems in order to integrate these virtual components into a novel invention-specific higher-level architecture. One embodiment of the invention includes at least one virtual operating system. In other embodiments, at least one virtual machine for a high-level programming language is integrated with at least one guest operating system or with the host operating system itself.

In one embodiment, a user interface running on the host operating system allows users to install, manage and uninstall guest operating systems and define general security policies. A programming interface makes these features available to developers. In one embodiment, the guest operating systems run in the background, invisible to the user (e.g., transparent), but available to applications.

An embodiment of the invention includes an implementation-specific communication channel to enable the transfer of information between the host operating system on one side and any resident guest operating systems and virtual machines on the other side.

Certain embodiments of the invention may use cross-platform libraries along with various implementations of the communication channel to enable the guests to access the resources of the host. One embodiment provides an implementation-specific client-side library on the virtual operating system. This library uses the communication channel to make network calls that request services from an integrated server-side cross-platform library residing on the host operating system. As a result, applications written to the APIs offered by the client-side library can access host operating system resources in the same way that applications native to the host platform do through the host-side cross-platform library.

An embodiment of the invention provides a unified security protocol that governs the permissions given to users and applications when they access the resources of the host as well as when they access the resources of all resident virtual operating systems and virtual machines.

An embodiment of the invention allows developers to pre-install, configure and test complex software solutions on a guest operating system. These software solutions may comprise virtual hardware, virtual operating systems, and virtual networks. The corresponding software packages may also be bundled with necessary components like native libraries to enable simple and safe installation across platforms and languages. Each package generates a record of its installed components which then can be used by an uninstall program that may be run on the host operating system. As a result the rollout of such software solutions is made significantly safer and simpler by the invention.

An embodiment of the invention enriches various programming languages with new data types and instructions. This is realized through an implementation-specific guest-side library that communicates with the host-side emulation library. In addition to accessing host resources, for instance opening host network connections, creating graphical widgets by accessing native host libraries and other standard services, the guest-side library offers invention-specific APIs. These APIs enable developers to dynamically and programmatically instantiate, configure, modify and delete complete virtual computers, virtual operating systems and virtual networks. An embodiment of the invention makes the implementation of the new language features possible by enabling programs that run on a virtual operating system to effect calls to a host-side cross-platform library that provides these capabilities.

An embodiment of the invention improves on the abstractions available to programmers and users such as unification of system resources. It continues the ongoing evolution of computer platforms and provides users and programmers with a new universal set of computer abstractions by making system resources uniform.

An embodiment of the invention represents the operating system resources of different operating systems uniformly by dynamically translating them for the user. For instance, the invention provides a uniform virtual file system which dynamically links to all file systems on the host operating system. These virtual links are uniform in that the same naming convention is used for paths and directories which have similar functionality in all of the disparate host operating systems. Using this uniform file system, users and applications alike are guaranteed to find system and user files in the same place for all host systems. Users and programmers can thus work with all host operating systems without special knowledge of their conventions. Likewise, the process tables, the network stack, user and group data, configuration data and installed application data for the host and virtual operating systems are represented in a uniform way. In this way users and programmers working within the guest operating system can access all resources in a uniform and portable manner across operating systems. The invention thus provides a uniform, cross-platform environment that standardizes the bytecode, library APIs and environment in which applications run.

An embodiment of the invention enables device drivers on virtual operating systems to communicate with physical hardware devices even when no appropriate device drivers exist on the host operating system and no hypervisor is present. An embodiment of the invention is independent of any specific device drivers and may provide a device driver for any type of hardware device supported by the virtual operating system. An embodiment of the invention thus provides a means for device driver engineers to write a single device driver that can support multiple operating systems.

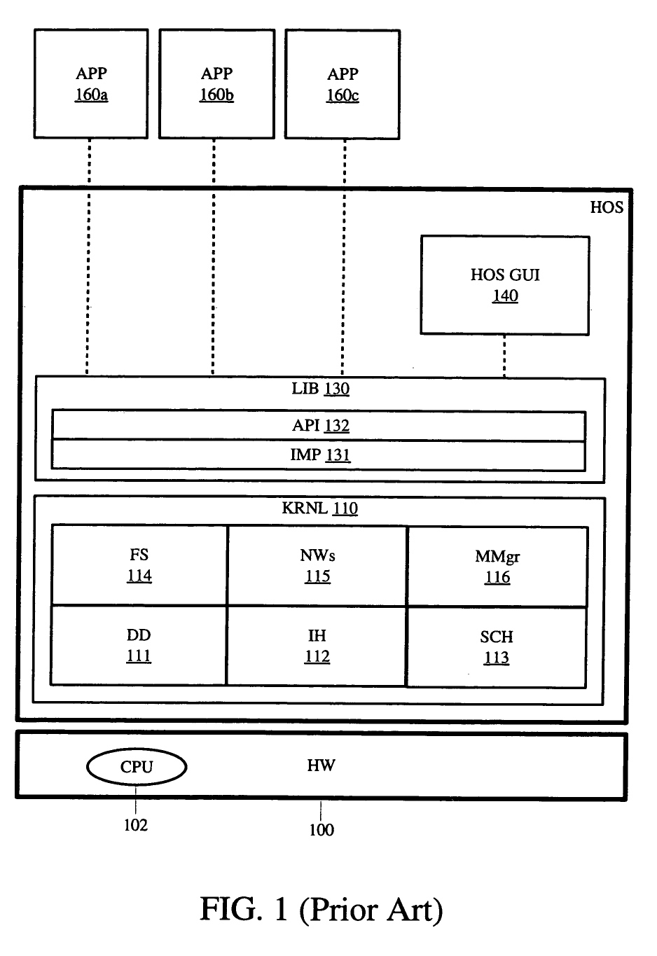

FIG. 1 depicts a common architecture of a conventional computer platform including an operating system and its main components. These components are interrelated layers of software that allow the user to communicate with the computer's hardware (HW) 100 including its central processing unit (CPU) 102 through installed applications (APP) 160a, 160b, 160c and through the graphical user interface (HOS-GUI) 140 of the operating system itself. Both the HOS-GUI (140) and the installed applications connect to the lower levels of the operating system through the same set of programming language libraries (LIB) 130. These libraries include an implementation (IMP) 131 that manages system resources in a convenient way while exposing a set of application programming interfaces (API) 132 to users and applications.

The lower level software of an operating system is know as its core services or its kernel (KRNL) 110. The kernel may include device drivers (DD) 111, an interrupt handler (IH) 112 a scheduler (SCH) 113, a file system (FS) 114, a network stack (NWS) 115 and a memory manager (MMgr) 116. The structure of the library and its APIs, and the various components of the kernel are specific to each operating system. This is one of the reasons that conventional applications depend on the specific operating system and hardware for which they are compiled. An application written to Linux APIs and compiled for an x86 processor for example, cannot normally run on the Macintosh PPC platform. The system shown in FIG. 1 is typical of a full-featured modern operating system for a stand-alone computer. For the purposes of the invention, an operating system may be any collection of software which directly controls a hardware device, regardless of the number of conventional operating system core services it provides.

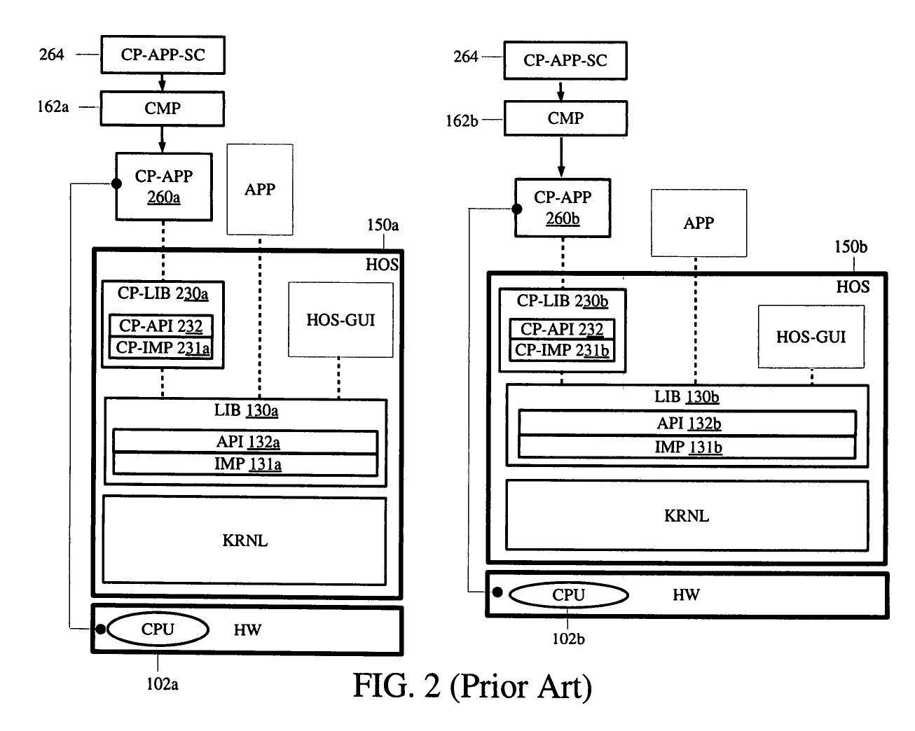

FIG. 2 depicts an example of how cross-platform libraries allow only one version of source code to be compiled for different operating systems. The drawing shows two different operating systems on which the applications (CP-APP) 260a and 260b are being executed. Each of these operating systems includes an OS-specific cross-platform library (CP-LIB) 230a and 230b installed on top of its native libraries (LIB) 130a and 130b. These cross-platform libraries present a uniform set of application programming interfaces (CP-API) 232 to the user or developer. The uniform CP-API allow developers to write only one version of application source code (CP-APP-SC) 264 using the single CP-API rather than the differing APIs 132a and 132b exposed by the libraries native to the two operating systems (HOS) 150a and 150b. The same version of source code can thus be compiled to run on both operating systems.

Although the use of the cross-platform library makes the source code universal, the application must still be compiled using two different compilers (CMP) 162a and 162b each designed to support one of the two different types of CPU 102a and 102b. The resulting binaries 260a and 260b are executable only on the appropriate physical CPU. As an example, a Linux program that uses the above cross-platform library would only be able to run on the Macintosh PPC platform if its source code was recompiled to produce an executable that could run on the Macintosh PPC CPU.

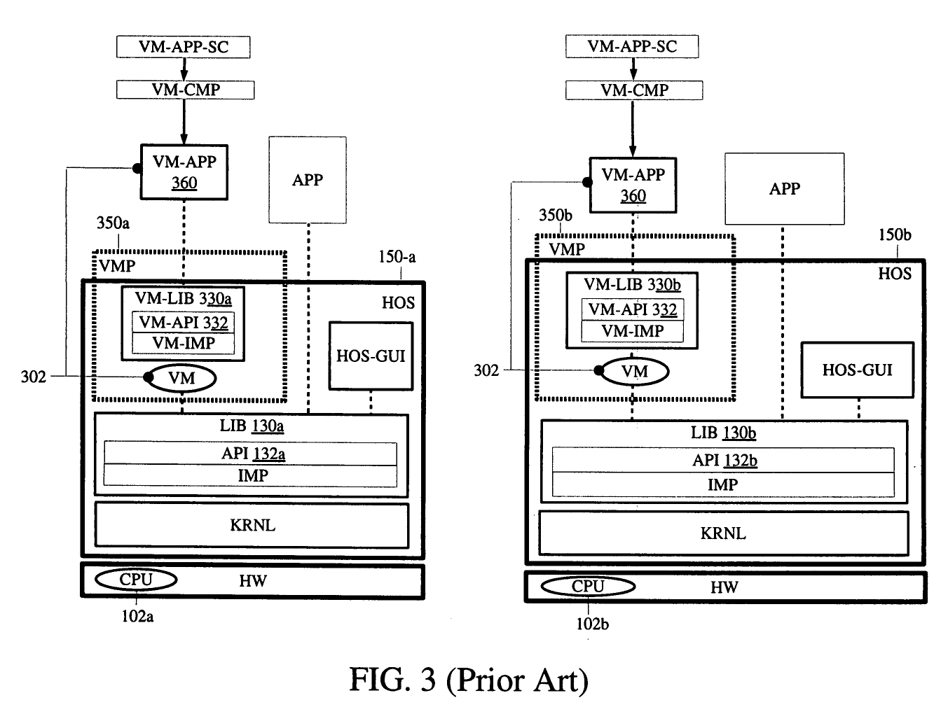

FIG. 3 depicts how software development platform virtual machines may be used for cross-platform execution of bytecode applications. The drawing shows two different host operating systems (HOS) 150a and 150b on which two virtual machines platforms (VMP) 350a and 350b have been installed for use as development platforms. Two identical instances of a bytecode application (VM-APP) 360 run on the two instances of the same virtual machine (VM) 302. The OS-specific cross-platform libraries (VM-LIB) 330a and 330b packaged with the virtual machine platforms 350a and 350b utilize the different application programming interfaces (API) 132a and 132b of the two HOS 150a and 150b.

A virtual machine increases the portability of application source code (VM-APP-SC) 364 by exposing a single set of cross-platform application programming interfaces (VM-API) 332 to bytecode applications. The bytecode of applications compiled or interpreted for the virtual machine run directly on this virtual machine rather than on the physical CPUs 102a and 102b. All virtual machine platforms of the same type expose the same VM and cross-platform library APIs to applications, regardless of the operating system on which they reside. Applications that are written for a particular virtual machine may be compiled into VM-specific bytecode before being distributed—this bytecode is then able to run on any operating system where the VM is installed.

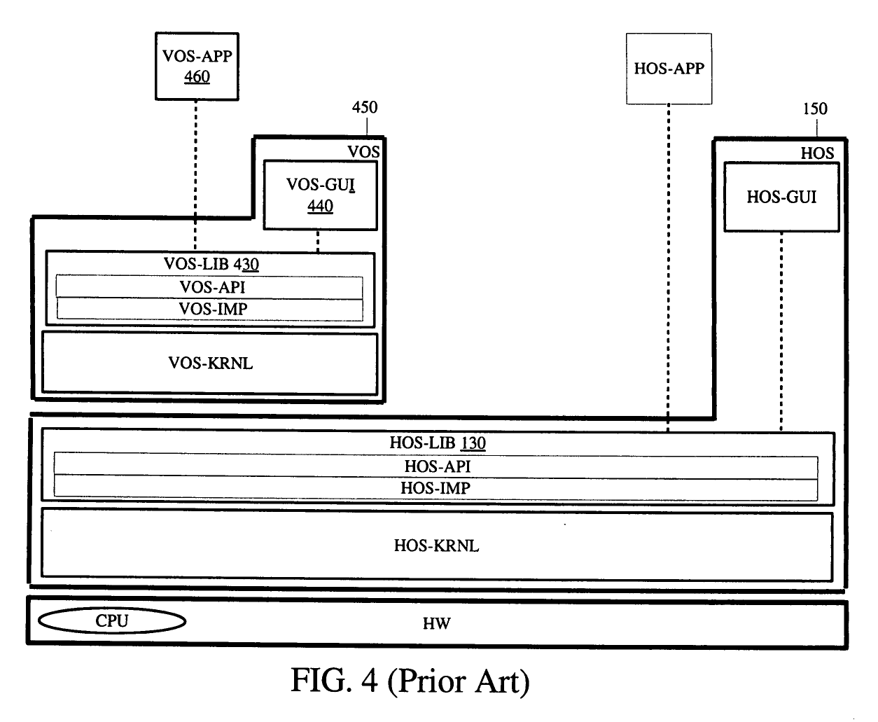

FIG. 4 depicts a generic virtual operating system. A virtual operating system (VOS) 450 shares hardware resources with another operating system which is considered to be the host (HOS) 150. As described in the background of the invention, there are a number of ways to implement such a system, depending on the level at which the resources are divided. In the embodiment depicted, the VOS is installed on top of a resident host operating system and accesses hardware resources through the host as if it were a host application.

A virtual operating system includes a complete set of operating system resources, including a kernel and a set of language libraries that are independent of those of the host. Applications (VOS-APP) 460 running on a conventional VOS as depicted in FIG. 4 are conventionally accessed through the VOS graphical user interface (VOS-GUI) 440. These applications have the appearance of guest VOS applications since they utilize the libraries of the virtual operating system (VOS-LIB) 430 rather than the libraries of the host (HOS-LIB) 130.

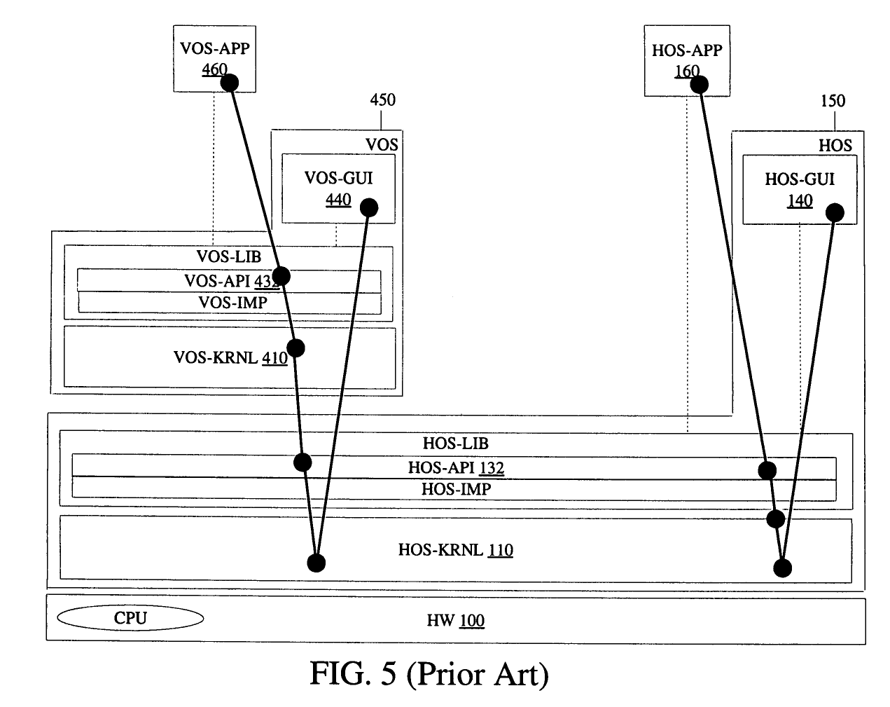

FIG. 5 is a functional diagram showing how applications running on the virtual operating system (VOS) 450 and applications running on the host (HOS) 150 conventionally access different levels of the hardware and software. In this illustration it is clear that the VOS application (VOS-APP) 460 is written to the APIs (VOS-API) 432 of the virtual operating system, accesses the hardware resources (HW) 100 through the kernel of the VOS (VOS-KRNL) 410, which itself is implemented through the APIs of the host operating system (HOS-API) 132. The user interface of the application is displayed in the context of the VOS GUI (VOS-GUI) 440. In contrast, the HOS application (HOS-APP) 160 is written to the APIs of the host operating system, accesses the hardware resources only through the kernel of the host operating system (HOS-KRNL) 110, and displays the user interface for the application in the context of the host operating system GUI (HOS-GUI) 140. In other words, the two applications use independent paths of execution.

Integrated Transparent Virtual Computer Platform

An embodiment of the invention arises from a way of combining, configuring and adapting existing technologies using implementation-specific components specifically designed to integrate these elements. The resulting integrated and transparent higher-level virtual computer platform uses virtual operating systems and virtual machines plus implementation-specific libraries and a communication channel in order to enable applications to run on a multitude of different host platforms. An embodiment of the invention includes a virtual operating system as in FIG. 4 and a host operating system as in FIG. 1. In various embodiments of the invention, the host operating system may include cross-platform libraries, as in FIG. 2 and/or virtual machines as in FIG. 3. These cross-platform libraries enable applications running on the virtual operating system to appear as if they are running on the host operating system with native look and feel.

In the descriptions below, there are many possible embodiments of the virtual hardware components. In embodiments where the invention includes a virtual CPU, the virtual CPU may be an emulation of a physical CPU, a virtual machine, and/or a number of virtual processing units designed for specialized tasks. In one embodiment the virtual hardware includes a virtual CPU and is capable of running applications compiled for CPU types other than the physical CPU used by the HOS. It is thus capable of running programs written in low-level programming languages that have been compiled to that specific CPU type. In one embodiment the virtual hardware includes a virtual machine and is capable of running applications that have been compiled to that virtual machine's bytecode. In one embodiment the virtual hardware includes other processing units designed for specific programming needs like a virtual Graphics Processing Unit (GPU), a virtual Physics Processing Unit (PPU), or some other specialized virtual processing unit and is capable of running bytecode written for those virtual processing units. As a further option, dynamic compilation may be used to increase the speed of execution of any of the code designed to run on virtual CPUs, virtual machines, or specialized virtual processors.

Aside from a virtual CPU and additional optional processing units, embodiments of the invention might also include additional virtual hardware devices like virtual sound cards, virtual motherboards, and virtual hard drives.

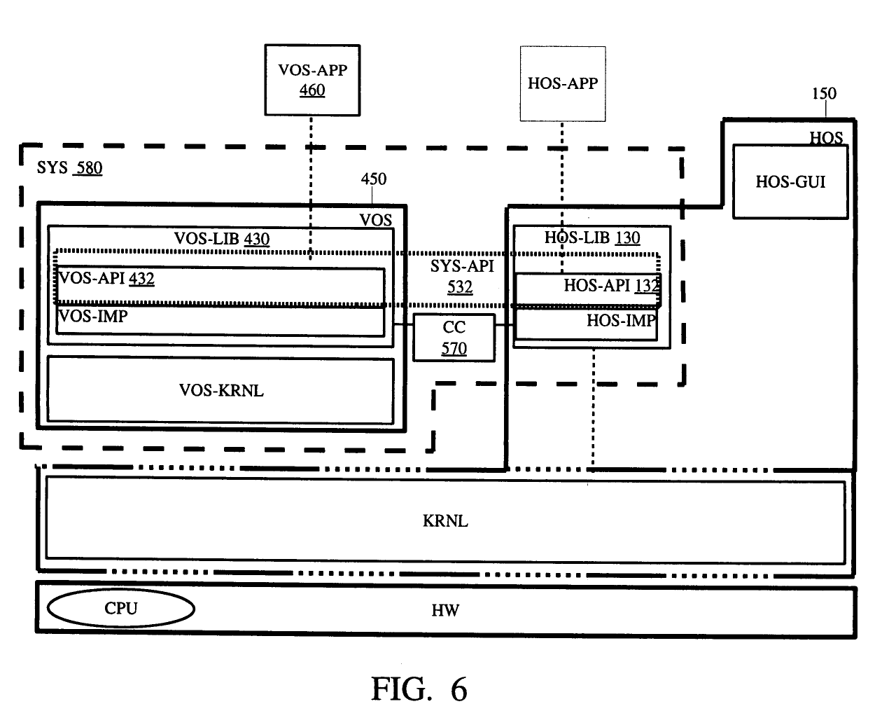

FIG. 6 depicts a computing system according to one embodiment of the invention. In one embodiment, system (SYS) 580 includes a modified virtual operating system (VOS) 450 installed on a host operating system (HOS) 150. Programming language libraries (HOS-LIB) 130 on the host are directly connected to libraries installed on the VOS (VOS-LIB) 430 through a communication channel (CC) 570 that allows an application (VOS-APP) 460 to access host resources through the APIs of the VOS library (VOS-API) 432.

In another embodiment, the application, when dynamically compiled to the host operating system, can access the resources of the VOS through the APIs of the host-side library (HOS-API) 132. In this way, some or all of the VOS library and the host-side library may be seen by users and applications as a single platform with a single set of APIs (SYS-API) 532 that may be used transparently. In an embodiment where the host-side library is a cross-platform library that includes graphical elements and the virtual operating system is modified so that it does not include a traditional graphical user interface, applications that run on the virtual operating system appear to be running on the host operating system with native look and feel.

The VOS used by some embodiments of the invention is similar to a virtual machine used as a development platform in that it is transparent to the user and applications running on it appear as if they are running on the host. They may be those of any existing or newly developed operating system. In one embodiment, the virtual operating system is Linux compatible operating system. Other embodiments could use Darwin, Solaris, Windows, BSD or another virtual operating system. In one embodiment, the VOS is a system emulator and includes a virtual CPU. In alternative embodiments, it includes a virtual machine for a higher-level programming language and/or virtual processors for specialized tasks such as a Virtual Graphics Processing Unit (VGPU) or a Virtual Physics Processing Unit (VPPU).

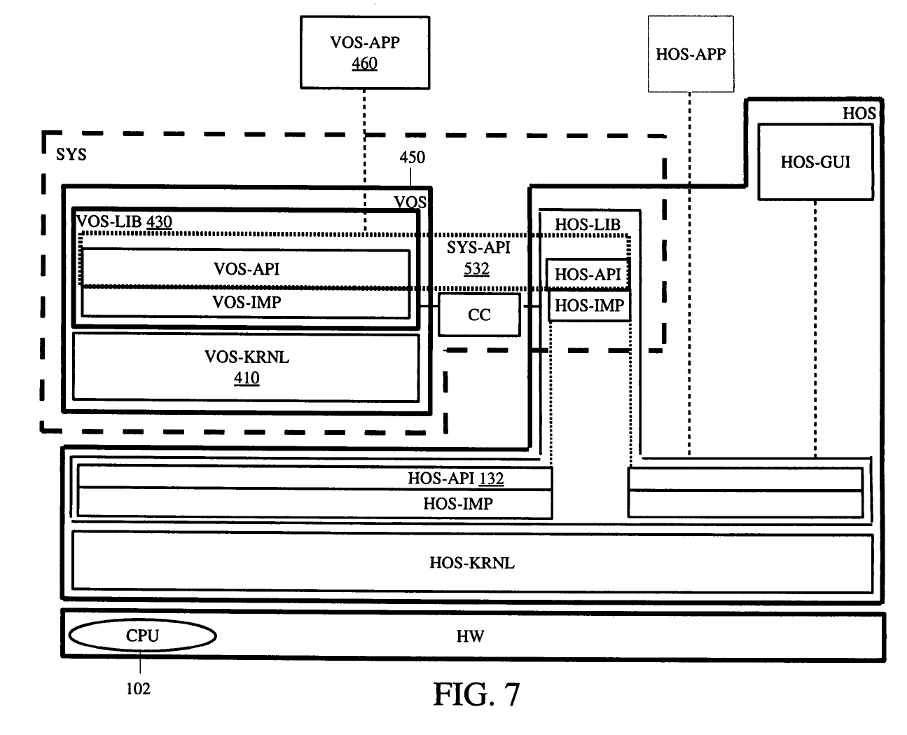

FIG. 7 depicts an embodiment of the invention in which the modified virtual operating system (VOS) 450 used is a virtual operating system which runs as if it were an application on the host operating system. This form of virtual operating system does not provide an emulated hardware CPU, so any application running on it must be compiled to the machine code native to the host processor (CPU) 102. This type of VOS works through the APIs (HOS-API) 132 of the underlying operating system to reserve disk space and memory for its own use and includes a virtual kernel (VOS-KRNL) 410 and virtual libraries (VOS-LIB) 430. Applications (VOS-APP) 460 that run on the application-level VOS use the APIs of the shared system platform (SYS-API) 532, but run on the physical processor.

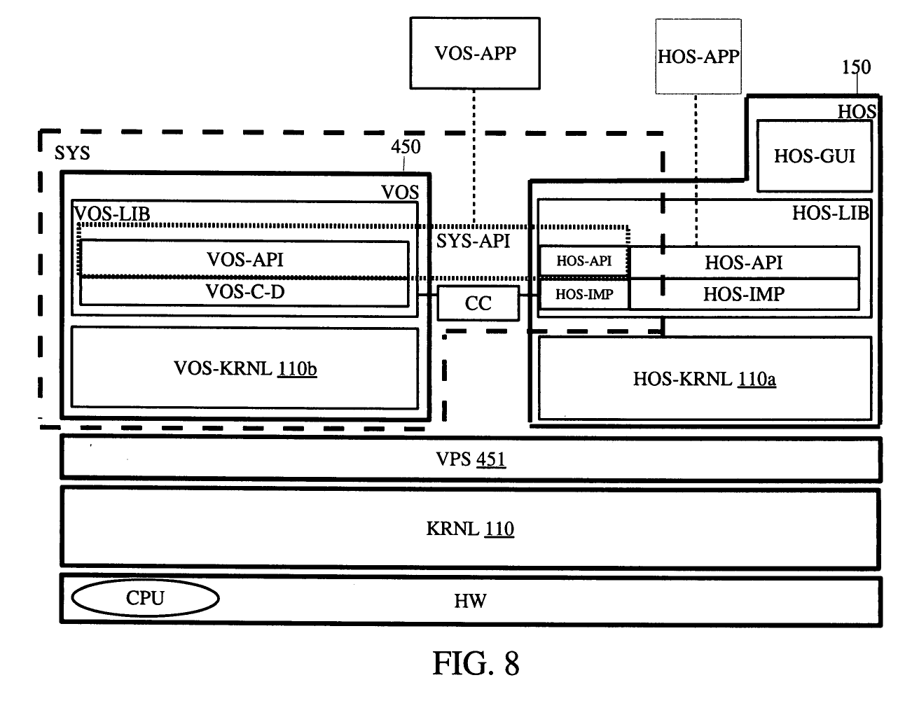

FIG. 8 depicts an embodiment of the invention in which the kernel of the VOS used is a partition of the kernel of the underlying operating system, commonly known as a virtual private server or VPS. In this case, a virtual private server (VPS) 451 partitions the original kernel (KRNL) 110. In some embodiments, the host kernel (HOS-KRNL) 110a and the virtual operating system kernel (VOS-KRNL) 110b are partitions of the original kernel. In other embodiments, the host kernel is the original kernel itself. Although they have similar kernels, the resulting host operating system (HOS) 150 and virtual operating system (VOS) 450 are distinct and separate from each other. For example, they may include different libraries, programs, configuration files, and interfaces, etc.

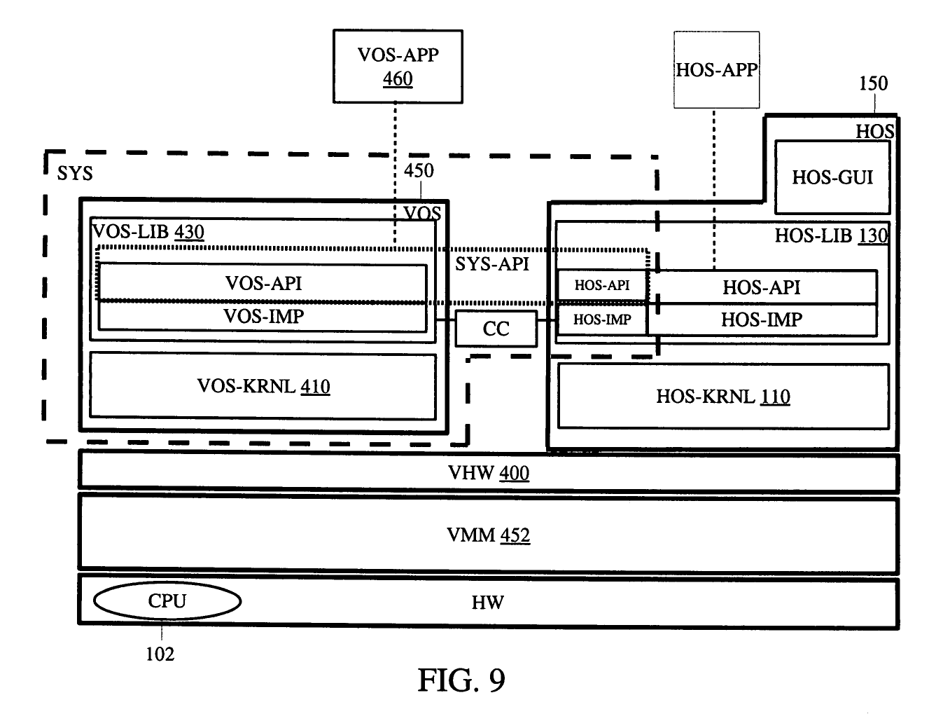

FIG. 9 depicts an embodiment of the invention in which the virtual operating system (VOS) 450 shares the hardware resources with the host operating system (HOS) 150 through a hypervisor. A hypervisor or virtual machine monitor (VMM) 452 is a minimal operating system that partitions the hardware into isolated environments so that different virtual operating systems can be installed on them. The VMM allocates hardware resources to each resident operating system. Conventionally, a standard operating system may be installed as a guest on top of the VMM as long as it is able to run natively on the physical processor (CPU) 102 and exported virtual hardware (VHW) 400. This operating system may include standard operating system features and resources such as kernels (VOS-KRNL) 410 and (HOS-KRNL) 110 and libraries (VOS-LIB) 430 and (HOS-LIB) 130

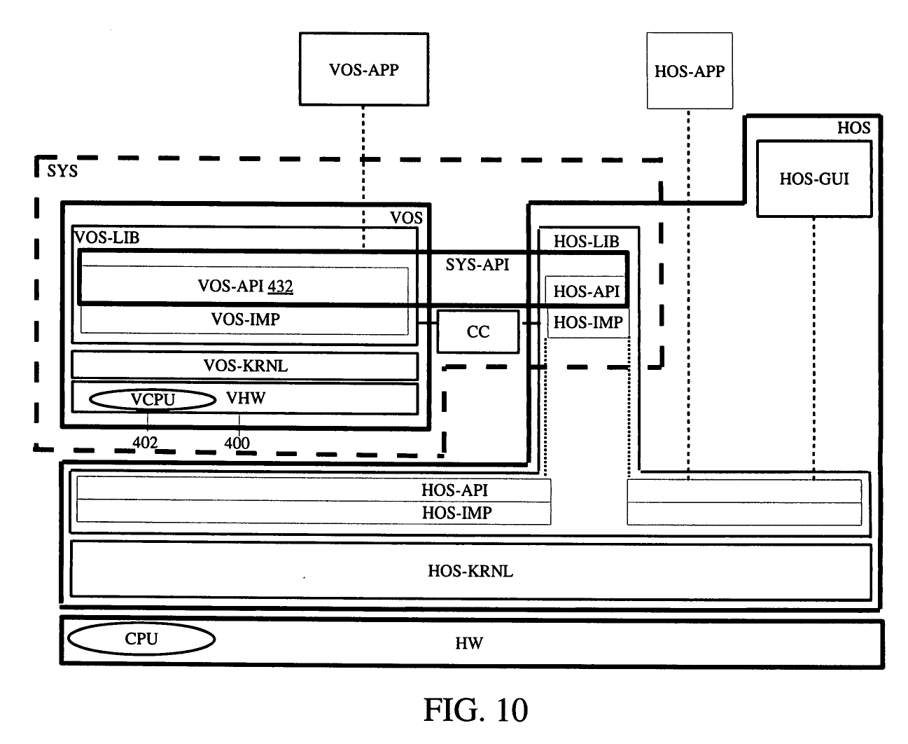

FIG. 10 depicts an embodiment of the invention in which the VOS used is a virtual operating system which runs as an application on the host operating system and includes a software emulation of a physical CPU. A system emulator VOS is comparable to a virtual machine in that it supports applications that utilize its APIs (VOS API) 432 and that are compiled for the virtual processor (VCPU) 402 and virtual hardware (VHW) 400. The virtual CPU may be a virtual machine for a software runtime environment like the Java virtual machine, or it may be a software emulation of a CPU with optional specialized processing units.

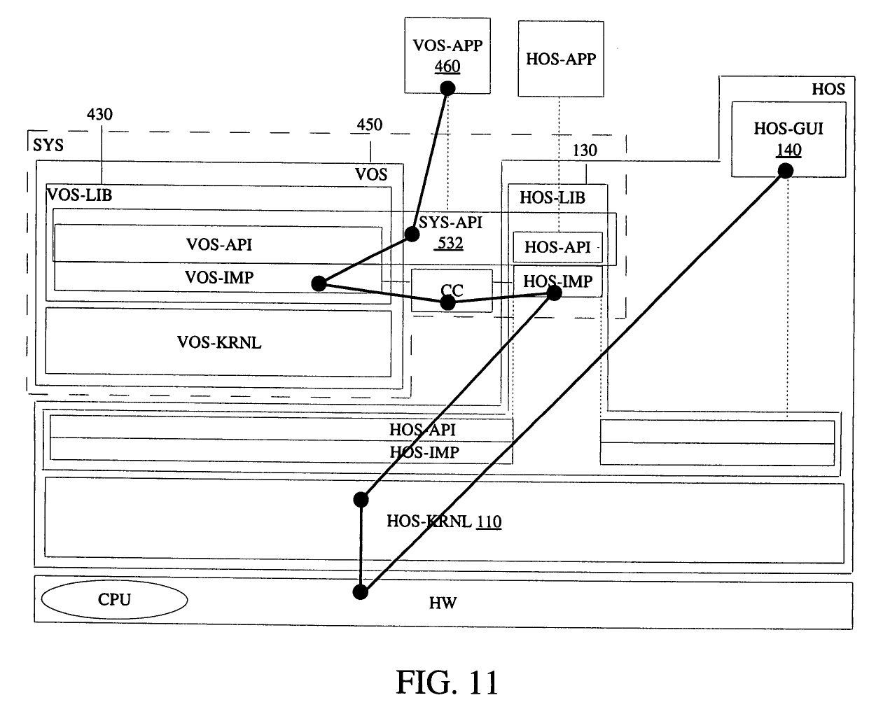

FIG. 11 is a functional diagram illustrating how an application running on the invention's virtual operating system accesses the available software and hardware resources of the host operating system. In this figure an application-level virtual operating system is depicted, but other embodiments of the invention that include other styles of VOS operate similarly. This figure shows an application (VOS-APP) 460 written to the system APIs (SYS-API) 532 and running on the virtual operating system (VOS) 450. Through the library on the virtual operating system (VOS-LIB) 430 the application uses the communication channel (CC) 570 to access the host operating system library HOS-LIB (130).

The host operating system library then uses the resources of the host kernel (HOS-KRNL) 110 and the host operating system's GUI (HOS-GUI) 140 to access host resources and give the application the appearance and user experience of an application running directly on the host. This figure may be compared to FIG. 4, depicting an application running on a conventional VOS, where the VOS application directly accesses the kernel and GUI of the VOS.

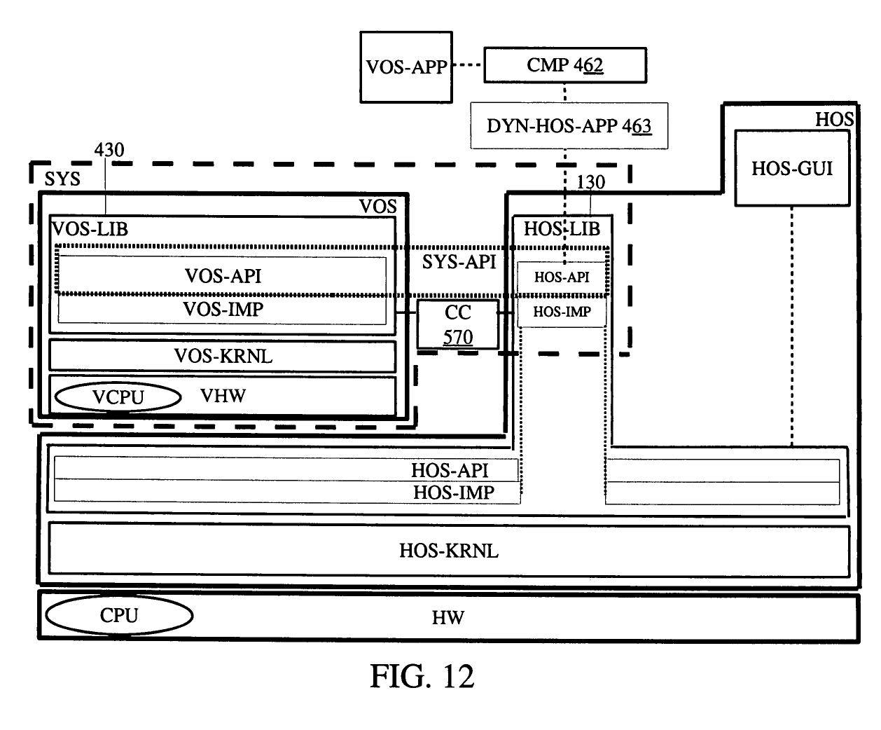

FIG. 12 depicts an embodiment of the invention in which the application is executed on hardware controlled by the host operating system through the use of dynamic translation where the compiler (CMP) 462 generates a dynamically compiled host application (DYN-HOS-APP) 463. In this case, the connection between the VOS library (VOS-LIB) 430 and the library installed on the HOS (HOS-LIB) 130 enables the application to access the resources of the VOS while running on the HOS through the communication channel (CC) 570 using reverse dispatch calls as described below.

Communication Channel

According to one embodiment, a communication channel is established by connecting existing and new software components in a unique way. In one embodiment, the library calls are directly translated in the application to native host library calls. Library calls to the guest library directly call equivalent APIs in the connected host-side library. This may be done using just-in-time compilation, through static compilation that links the two libraries, or a combination of both. If the two libraries are implemented in a higher level programming language that uses a virtual machine or interpreter, code translation may be done by simply making a library call in the high-level language.

In another embodiment, the communication may take place through a virtual device, such as a serial port, a USB device, a sound card, and/or another piece of virtual hardware. In this embodiment, information sent to the virtual hardware is directly forwarded to the host library.

In another embodiment, the communication may take place through a virtual operating system primitive. In the case where the operating system primitive is the network stack, the two libraries could communicate using SOAP, XML-RPC, CORBA, DCOM or another similar method.

In short, a communication channel allows the implementation and execution of cross-platform applications by connecting a VOS library directly with a HOS library, regardless the specifics of the implementation of the communication channel itself.

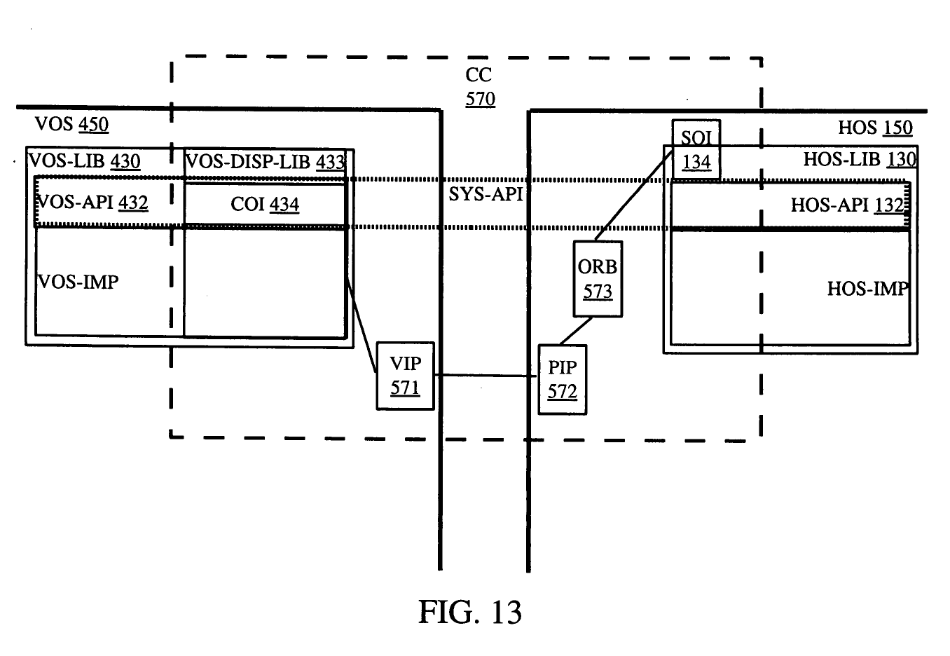

FIG. 13 depicts one of a number of possible embodiments of a communication channel between a guest and a host. For clarity, the specific embodiment of the communication channel (CC) 570 depicted here will be used for reference throughout the rest of the description of the invention. In a particular embodiment, the communication channel uses Common Object Request Broker Architecture (CORBA) to dispatch calls from the virtual operating system library (VOS-LIB) 430 to the host operating system library (HOS-LIB) 130 via a virtual network. However, it will be appreciated that other types of communication mechanisms may be utilized.

According to one embodiment, HOS is assigned with an identity, such as, for example, a pseudo IP address (PIP) 572 by the VOS. All requests for that pseudo IP are redirected to the HOS. The VOS, in turn, is given a virtual IP address (VIP) 571 that it uses to communicate with the pseudo IP address of the HOS. According to one embodiment, the dispatch library (VOS-DISP-LIB) 433 included in the libraries on the VOS includes client object interfaces (COI) 434 within the application programming interfaces (VOS-API) 432 of the VOS library (VOS-LIB) 430. When the system is started, according to one embodiment, this dispatch library connects through the virtual network to the Object Request Broker (ORB) 573 that resides on the (HOS) 150. The object request broker acts as a server and registers the server object interfaces (SOI) 134 which wrap the APIs of the host-side library (HOS-API) 132. When library calls are made to the dispatch library on the (VOS) 450, corresponding objects are created and actions are performed in the host-side cross-platform library utilizing standard CORBA technology.

Throughout this application, the terms “dispatch library” or “dispatch call” refer to the implementation of the communication channel as illustrated in FIG. 13 or a similar implementation. Likewise, the terms “reverse dispatch library” or “reverse dispatch call” refer to a system in which the dispatching mechanism and its associated library reside on the VOS, while the associated client library resides on the HOS. This latter system, which may coexist with the above-described dispatch library, is used in instances in which the host needs to access the VOS resources.

For example, in an alternative embodiment of the invention, the speed of execution may be increased when binaries compiled to the VOS and its associated virtual CPU are dynamically translated to machine code using the instruction set of the physical CPU. Library calls, in turn, may be forwarded to calls to a library on the host operating system through the communication channel. In one embodiment, a guest library may still be needed to allow the application to access the resources of the VOS so that it may take advantage of other novel aspects of the invention. This may be accomplished by having the host library make reverse dispatch calls back to the VOS to create the illusion that the application is running in the context of the virtual operating system. In one embodiment of such a system, all system calls are sent from the HOS to the VOS using reverse dispatch calls to a reverse dispatch library that wraps the system calls of the virtual operating system so they may be accessed by the host.

Because the dispatch library of the VOS connects in this way to the built-in libraries of the HOS, applications that run on the VOS can access the resources of the HOS and have the look and feel of applications that run natively on the HOS. There are a number of cross-platform libraries available for a variety of programming languages. One embodiment of the invention utilizes at least one cross-platform C/C++ library, but other embodiments may also utilize libraries for other languages.

Overlaid Security

Because some embodiments of the invention enable resources to be shared, it is useful to allow host and guest resources to interact with each other. As a result, there is a need for a security mechanism that allows control of the access that these virtual components have to the host and vice versa. A fundamental tenet of security for a complex system including virtual operating systems and virtual machines is that the host be well protected from the activities of the guests so that users and programs can only access resources and perform actions for which they have been granted privilege. An embodiment of the invention protects the host by providing a simple and uniform security mechanism for the entire system.

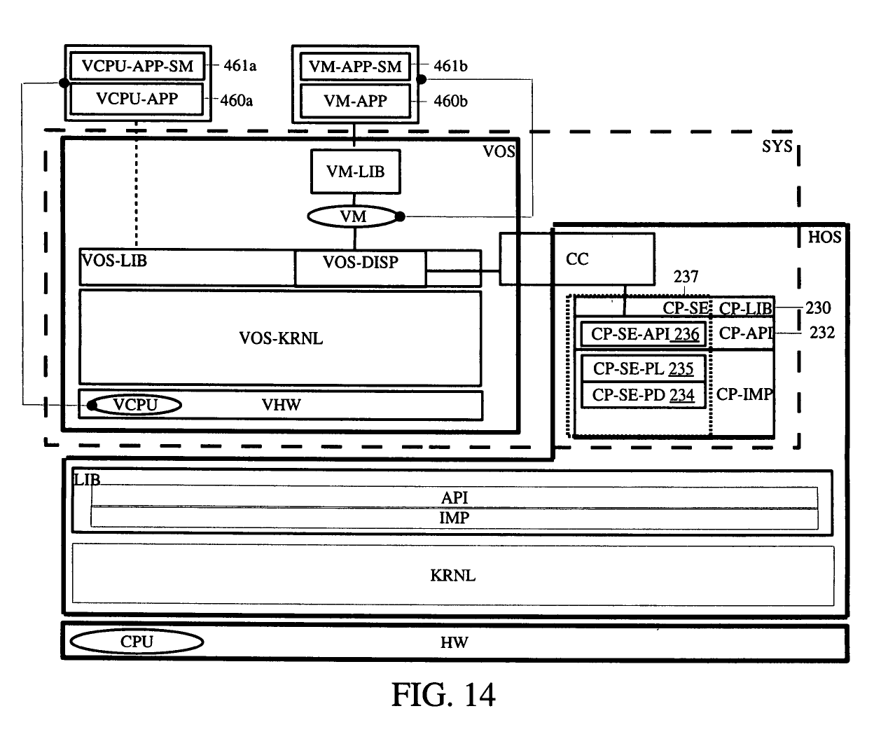

FIG. 14 depicts an embodiment of the invention including an integrated virtual security system. In this embodiment, the implementation-specific cross-platform library (CP-LIB) 230 includes a security engine (CP-SE) 237 that makes the cross-platform library the single entry point for platform-wide security policy enforcement. In one embodiment, the security engine includes an application programming interface (CP-SE-API) 236, a unit implementing the policy logic (CP-SE-PL) 235 and data structures containing the policy data (CP-SE-PD) 234. The applications (VCPU-APP) 460a and (VM-APP) 460b that access the application programming interfaces (CP-API) 232 of the cross-platform library through the dispatch library (DLIB) 433 each provide a security manifest (VCPU-APP-SM) 461a and (VM-APP-SM) 461b that specify which functions of the cross-platform APIs each application is allowed to use. The security engine uses these security manifests to make policy decisions and permit or deny access to the host resources.

In alternative embodiments, the virtual machine platform libraries are ported to the guest and/or host libraries so that applications that run on top of the virtual machine also comply with the security policy. In another alternative embodiment, the security system translates the security manifest received with an application to the forms expected by the different subsystems of the invention.

Compound Executables

According to one embodiment, a binary residing on the virtual operating system may include not just the machine code or bytecode of a single application or library, but sets of interacting applications, virtual operating systems, virtual networks, virtual hardware devices, or a combination of these. This makes it possible to distribute a single compound executable that includes an entire system of virtual computers, operating systems and programs acting in concert. This opens a window to whole new galaxies of complex yet easily distributed software applications.

In one embodiment, applications are loaded onto the virtual operating system as bundles of files, also referred to as a “compound executable”. A compound executable may include much more than simple applications, including components that make up virtual networks of computers, devices and operating systems. The actual form of a compound executable may vary. It may be a compressed archive comprising other archives, a directory of directories on the host side, a bundle of virtual file systems, a set of real files systems loaded on a hard drive, or any other of the many possible permutations of file and directory groupings.

The elements included in these bundles may simply be applications. In one embodiment, the binaries included in a single bundle may include any type of machine code or bytecode capable of being executed on any resident virtual machine, emulated CPU or physical CPU. This embodiment of the invention thus seamlessly integrates and executes applications that comprise heterogeneous types of machine code and bytecode. Through this mechanism the system executes a sophisticated form of bytecode which combines executables compiled for more than one development platform. These bundles may alternatively comprise software libraries or extensions to existing software libraries.

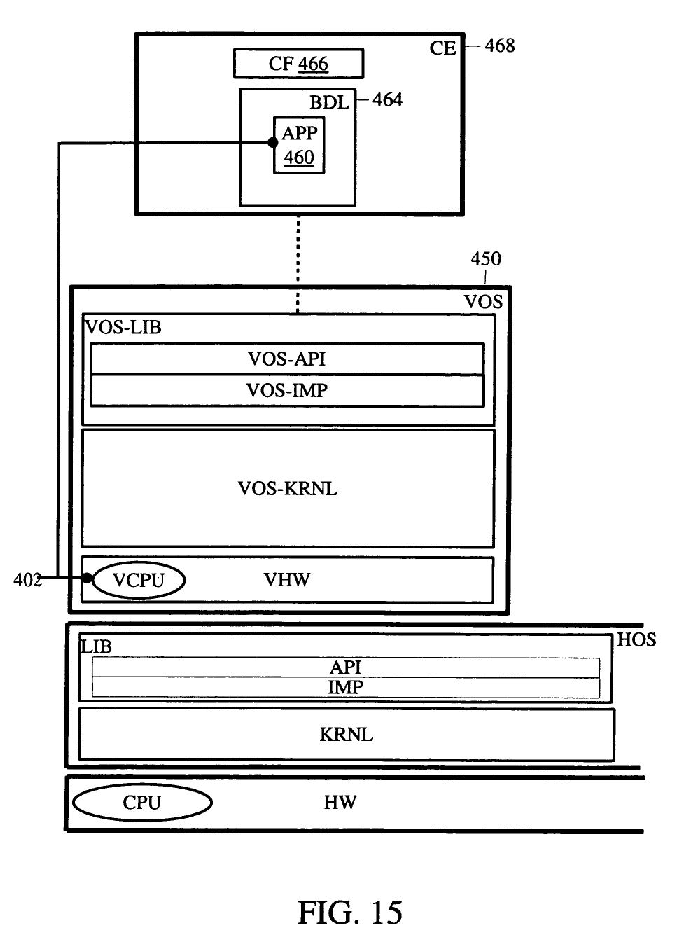

There are several extensions according to various embodiments of the invention. In one extension, the compound executable includes a “control file” specifying the execution order and configuration details of the components it includes. In another extension, the compound executable includes a configuration file that can configure configuration details of the application. A graphical interface may also be included that allows users to easily edit these details. FIGS. 15, 16, 17, 18 and 19 depict examples of the forms a compound executable according to certain embodiments of the invention.

FIG. 15 depicts one embodiment of the invention executing a simple application bundled into a compound executable. In this embodiment, the compound executable (CE) 468 includes a control file (CF) 466 and a bundle (BDL) 464. The control file comprises instructions that the default virtual operating system (VOS) 450 uses to execute the bundle. When this bundle is executed, it loads a single application (APP) 460 onto the VOS where it is executed by default on the virtual CPU (VCPU) 402.

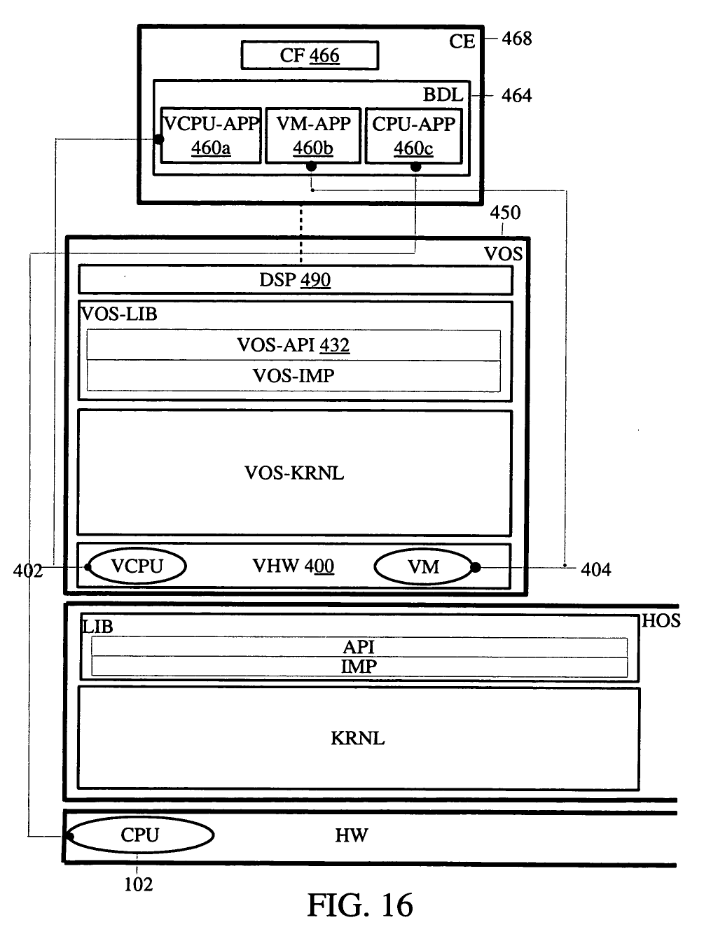

FIG. 16 depicts another embodiment of the invention having a run-time dispatcher executing a compound executable including several heterogeneous applications compiled for more than one installed virtual or physical CPU. In this embodiment, the invention includes an additional development-platform virtual machine (VM) 404, virtualized hardware resources (VHW) 400 of the virtual operating system (VOS) 450, along with virtual machine application programming interfaces included among the APIs of the virtual operating system (VOS-API) 432. In this embodiment, the system is capable of running high-level bytecode or dynamic language applications as well as applications that run natively on the emulated CPU (VCPU) 402 and applications that run on the underlying physical CPU (CPU) 102.

The compound executable (CE) 468 may include more than one application. Like the simpler example depicted in FIG. 9, this compound executable includes a control file (CF) 466 and a bundle (BDL) 464. In contrast to the bundle in FIG. 9, this bundle includes three applications: one application (VCPU-APP) 460a that runs natively on the virtual CPU, one application (VM-APP) 460b comprising high-level bytecode for the available virtual machine, and one application (CPU-APP) 460c that runs on the underlying physical CPU 102. The control file includes instructions that a dispatcher (DSP) 490 on the default VOS 450 uses to execute the bundle. The control file also includes instructions regarding the execution order of the applications.

In one embodiment, as it manages the execution of the various applications within the compound executable, the dispatcher on the default VOS examines the MIME type of each of the applications. In other embodiments, it determines the type of application using other techniques known by those familiar with the state of the art. In all embodiments, the dispatcher dynamically refers the execution of each application to the appropriate virtual CPU, virtual machine, or physical CPU.

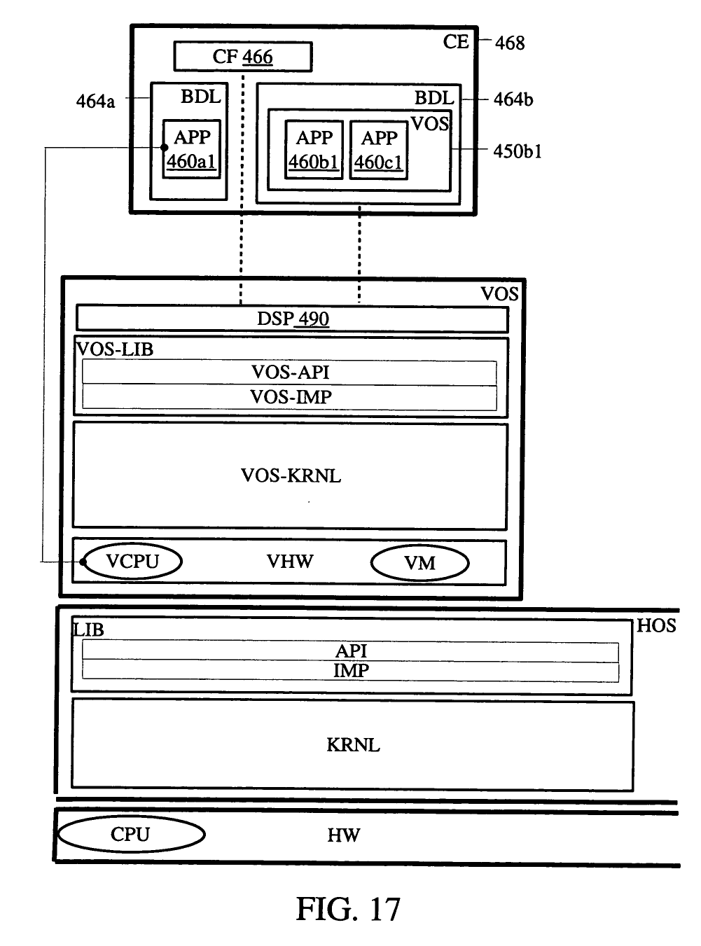

FIG. 17 depicts an embodiment of the invention preparing to execute a compound executable. In one embodiment, the compound executable (CE) 468 includes two bundles (BDL) 464a and 464b. The first bundle includes an application (APP) 460a1 that is executed in the same manner as the application (APP) 460a from FIG. 10. The second bundle 464b is much more complex and includes a new virtual operating system (VOS) 450b1 which is in the form of a compressed file system and is pre-installed with the compiled applications (APP) 460b1 and 460c1. The files included in the file system may be sufficient to boot VOS 450b1 or may be overlaid onto the root file system of a previously installed operating system to make a new variation of that operating system.

The compound executable also includes a control file (CF) 466, which in this case includes specific instructions regarding the execution of the bundles. The control file might instruct the dispatcher (DSP) 490 to boot the bundle as the root file system of VOS 450b1, to overlay the files onto an existing bootable file system, or simply to mount them onto a previously installed VOS. When the compound executable is executed, the dispatcher examines the control file to find a description of the operating system included in the file system bundle and then proceeds to extract and boot the VOS 450b1 using the file system. The control file also specifies the physical or virtual hardware that the operating system should run on and the operating system's configuration, for example, including an IP address it should use, most of which are dynamically created upon execution.

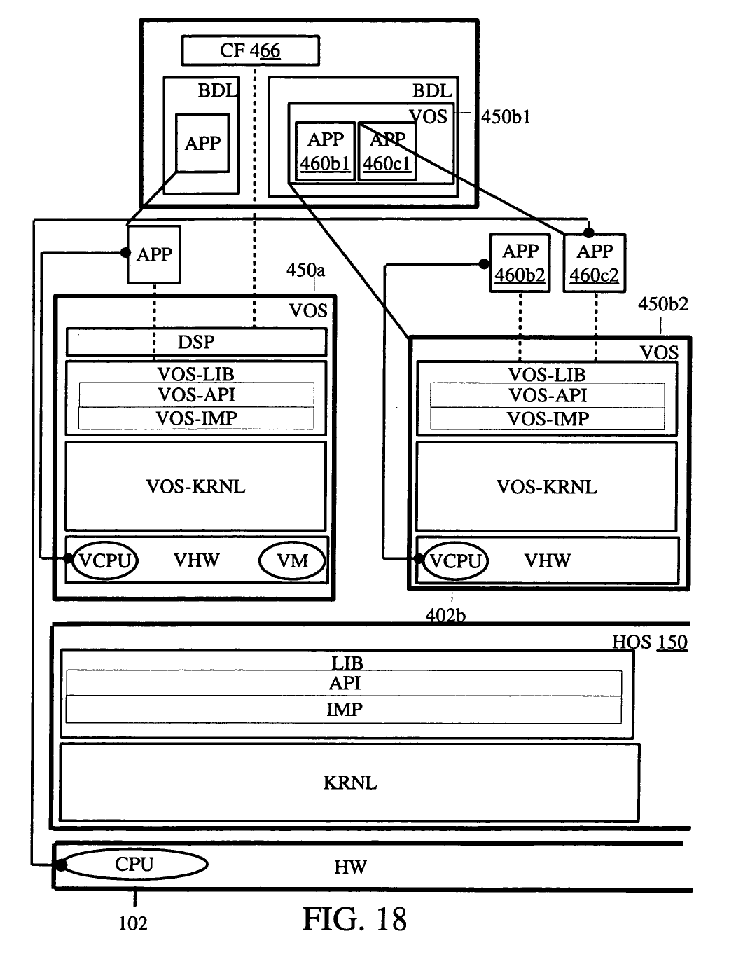

FIG. 18 depicts the system of FIG. 17 after the new virtual operating system has been booted, according to one embodiment. The newly extracted and booted virtual operating system (VOS) 450b2 is installed on the host operating system (HOS) 150 alongside the default virtual operating system (VOS) 450a. The bundled virtual operating system (VOS) 450b1 is shown pre-installed with two compiled applications (APP) 460b1 and 460c1. Once the new VOS 450b2 is booted, the dispatcher (DSP) 490, again instructed by the control file (CF) 466 and the MIME types of the compiled applications 460b1 and 460c1, executes each of them on the appropriate virtual processor (VCPU) 402b or physical processor (CPU) 102. In this case, application (APP) 460b2 is executed on the virtual CPU 402b residing on the VOS 450b2 while application (APP) 460c2 is executed on the physical CPU 102.

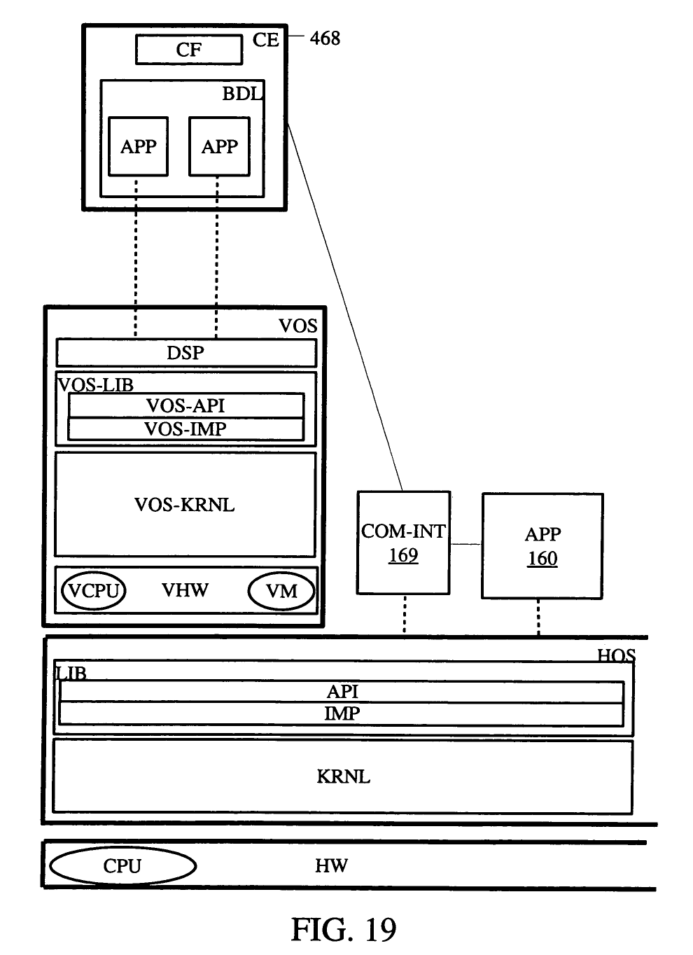

FIG. 19 depicts an embodiment of the invention in which a compound executable (CE) 468 is accessed through a component interface (COM-INT) 169. In this embodiment, the compound executable is accessed through a component interface to allow the compound executable to be used as a software component by another application running on the host operating system (HOS-APP) 160. In one embodiment of the invention, as shown in FIG. 19, the software component technology is KPART and a C++ wrapper is written that wraps the compound executable and creates a component factory for creating instances of the compound executable.

When the component is loaded, the graphical interface of the compound executable is displayed through a QT canvas making it possible to embed compound executables in KDE applications. In alternative embodiments, SOAP, XML-RPC, XPCOM, COM, DCOM, CORBA, or any other component technology used by an application can be used to wrap the compound executable. Alternatively, the dispatcher could be wrapped in the component interface so that compound executables could be loaded without individual wrapping.

It will be appreciated that there are many possible implementations according to certain embodiments. In particular, any mixture of virtual hardware, virtual machines, and virtual operating systems can be combined to form another embodiment. For example, in one embodiment, a virtual x86 64-bit CPU, a Parrot virtual machine, and a Java virtual machine may be used. In another embodiment, these virtual processors might be replaced with the NET virtual machine or a high-level interpreter for a language like Python.

In other embodiments, different virtual devices or specialized processors might be present and different virtual operating systems might be running therein. In addition, in any embodiment that includes both a virtual CPU and a virtual machine, the object model exposed by applications and libraries compiled to the VOS using lower-level languages may be compatible with the object model used by the various virtual machines. This compatibility may be realized through any one of a number of well-known techniques for integrating a virtual machine's object model with the object model of a low-level programming language.

There are also alternative embodiments that improve the performance of the invention. In one embodiment, instead of running virtual machine platforms directly on the VOS, virtual machines and interpreters may run directly on the HOS instead by using APIs that are implemented in APIs on the host-side and that dispatch back to the VOS. In this embodiment, the use of reverse dispatching can create the illusion for applications that run on the virtual machines or interpreters that they are running natively within the VOS. This illusion can be made complete if the programming language VM is ported to and uses the APIs of a reverse dispatch library on the HOS which, in turn, calls the dispatch library on the VOS. Alternatively, the reverse dispatch library may directly translate calls to the dispatch library that exists on the VOS.

In this way, contrary to a conventional virtual machine technology, it allows for the complex integration of multiple technologies using multiple virtual machines and virtual operating systems without significant performance degradation. This makes it possible to create portable and interoperable cross-platform binaries that can be written in a variety of low-level and high-level languages and to distribute binaries that include virtual machines, hardware, operating systems, and networks.

New High-Level Data Types and Instructions for Programming Languages

An embodiment of the invention makes it possible for virtual operating systems, virtual machines and virtual networks to be created, installed, configured, accessed, controlled, managed and/or deleted programmatically as variables in a computer program. These complex virtual systems become dynamic and flexible. Thus, they no longer require physical hardware components and disks that include application install files.

In one embodiment, virtual resources can be instantiated and controlled through libraries installed on a virtual operating system. In another embodiment, they are objects or classes in an object-oriented programming language installed on the virtual operating system or native data types in programming languages with alternative programming models. In an object-oriented embodiment, virtual computers, virtual devices, virtual operating systems, and/or virtual networks are included as new classes for the object-oriented programming languages that run on the virtual operating systems.

In these embodiments, the enrichment of existing languages allows programmers to dynamically instantiate and to configure virtual networks, computers, operating systems and/or their components in a similar way they would open and close a file or instantiate a string. By extending the programming languages that run on the virtual operating system, an embodiment of the invention provides a cross-platform environment for using these new high-level data-types, instructions and classes.

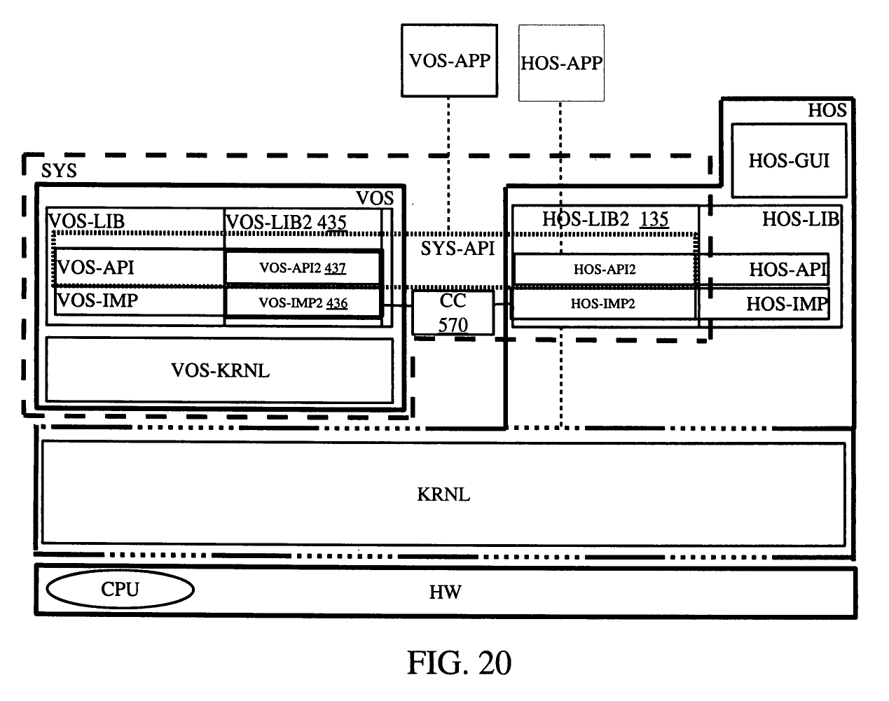

FIG. 20 depicts one embodiment of this library. In this embodiment, a dedicated dispatch library (VOS-LIB2) 435 is installed on the virtual operating system and a host-side emulation library (HOS-LIB2) 135 is installed on the host. In the implementation of this library (VOS-IMP2) 436, calls made to the corresponding APIS (VOS-API2) 437 of the VOS library are forwarded through the communication channel (CC) 570 to the host-side emulation library which creates the virtual resources requested by the program running on the virtual operating system.

In one embodiment, these dispatch calls return a programmatic reference that represents these complex features to the application running on the guest operating system. These programmatic references allow the virtual operating system program to further manipulate the virtual resources that have been instantiated. In alternative embodiments, different communication channels are used, including dynamic compilation as detailed above. In other embodiments, the programming model of a programming language on the virtual operating system may be extended to include the virtual resources as native data types by using the aforementioned programmatic references.

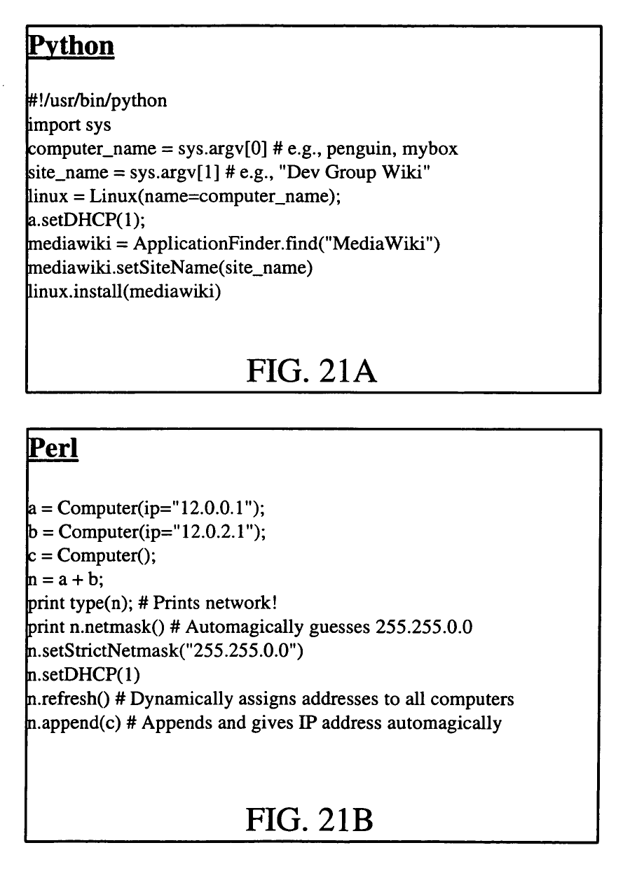

In this embodiment, from the perspective of the programmer, it is possible to dynamically create and manage virtual networks of devices, operating systems, and applications within the context of a program. The sample classes in FIGS. 21A and 21B illustrate examples of these new programming classes as they may be used in the Python and Perl programming languages.

Uniform Access to Resources

An embodiment of the invention provides a standardized environment, which allows the resources of a variety of operating systems to be accessed in a uniform manner. Conventional virtual machine platforms enable uniform cross-platform bytecode execution and allow developers to use uniform APIs but they do not provide a uniform environment. By providing such an environment the invention brings the state of the art of cross-platform development to a new level.

Different operating systems have different file system layouts, different methods of program communication, and different network stacks. The wildness of their environments forces programmers to develop platform-specific code in order to work with their system resources even when using cross-platform APIs. For example, a cross-platform API for opening and saving files is insufficient for programs that need to save files to a user's home directory since home directories have different paths on different operating systems.

An embodiment of the invention eliminates the wildness of the operating system in which programs run. In one embodiment, it accomplishes this by creating a uniform, integrated environment for users and developers that virtualizes the resources of the underlying host in a uniform manner on the guest operating system. This may be done at the kernel level by coupling the low-level resources of the guest and the host operating systems or at a higher, more functional level with a set of shell commands or a GUI. In cases where the host operating system is lacking a resource or feature, according to one embodiment, the uniform representation of the feature may be emulated or eliminated. By providing uniform representations of host resources, the invention offers a robust and stable development environment, allowing code written for the invention to uniformly access resources across different host platforms.

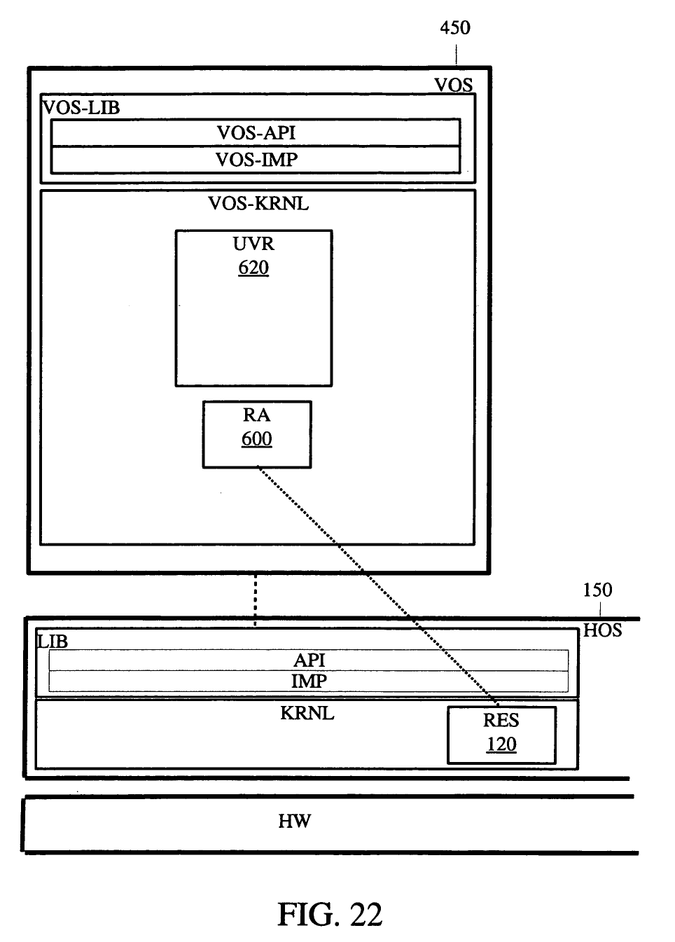

FIG. 22 is a depiction of the system and method used to implement a uniform integration of resources according to one embodiment. In this embodiment, a resource (RES) 120 on the host operating system is connected to a resource adapter (RA) 600 on the virtual operating system. The resource adapter produces an integrated uniform virtual resource (UVR) 620 on the virtual operating system, which maps the properties of the host resource to a uniform standard and optionally integrates this resource with the similarly mapped resource on the virtual operating system.

Uniform File System

A uniform file system is the most fundamental prerequisite for a uniform cross-platform development platform. In one embodiment, a uniform file system standardizes the location of files that appear in different locations on different operating systems. For instance, some or all of the network configuration files for the various operating systems may be stored in the virtual directory, such as /Configuration/Network/, some or all of the user files for a user, for example, user “maria”, from the various operating systems may be stored in the directory of /Users/maria, and some or all of the device driver file representations could be stored in /Devices. Note that the above configurations are described by way of examples, not by way of limitations.

Since these files are commonly stored in different locations on different operating systems, this uniformity of location is of great value to a cross-platform application developer. It allows users and programmers to reliably find and manage files. Instead of writing platform-specific code to find and manipulate files and file formats, the programmer need only write code once to uniformly manage the data stored in the different host environments. In one embodiment, the same principle of file system unification and uniformity may be extended to present a virtualized uniform file system modeled after the operating system of the user's choice.

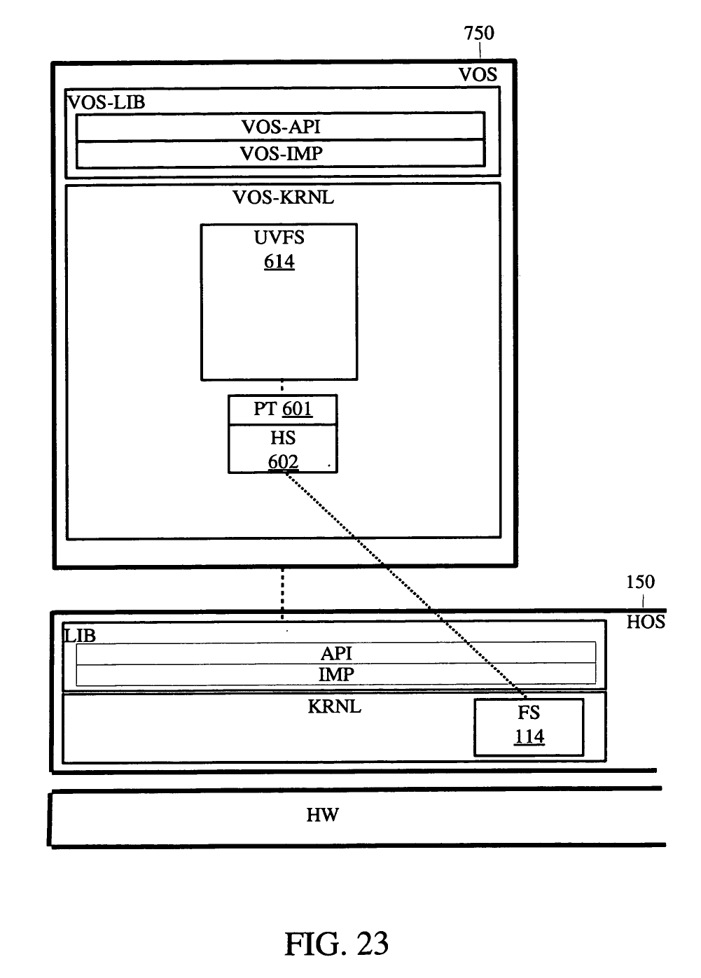

FIG. 23 depicts an embodiment of a cross-platform uniform file system. In this embodiment, the file system (FS) 114 of an operating system (HOS) 150 provides a structure for accessing the data stored on the hard drive. In one embodiment, a uniform virtual file system (UVFS) 614 on the guest operating system (VOS) 450 uniformly represents the file system on the host operating system. In one embodiment, the file system of the virtual operating system is built by an existing technology similar to HostFS (ref), which allows a directory on the host operating system to appear transparently as the file system of the guest. In this embodiment, a simple uniform mapping function is added to the HostFS-like technology using a path translator (PT) 601 to dynamically create a hash structure (HS) 602 that maps file paths on the host operating system to functionally uniform locations on the virtual operating system. In the simplest form of the embodiment shown in the figure, directories and files are mapped to a uniform representation using a simple host-specific look-up table.

In a more complex embodiment, system data from a variety of locations on the hard disk may be mapped to a uniform location and the information itself may be reformatted into a uniform format. For example, TCP/IP information is stored in the Windows' registry on Windows, while the same information is stored in text files in the “/etc” directory on Linux. This registry data on a Windows host may be written to text files of the same structure and including analogous data as the corresponding text files on a Linux guest. When TCP/IP information is changed on the host, the text files can then be automatically rewritten so that they remain synchronized with the data in the Windows registry. Likewise, when the TCP/IP configuration is changed on the guest, the changes can be propagated back to the host.

Uniform Process Management and Communication

An embodiment of the invention makes other operating system resources uniform, including the process manager and the process communication system. This gives users, developers and applications a uniform view of all of the processes running on the guest and the host and thus provides a uniform mechanism to either manually or programmatically monitor and manage the processes running on a variety of host systems.

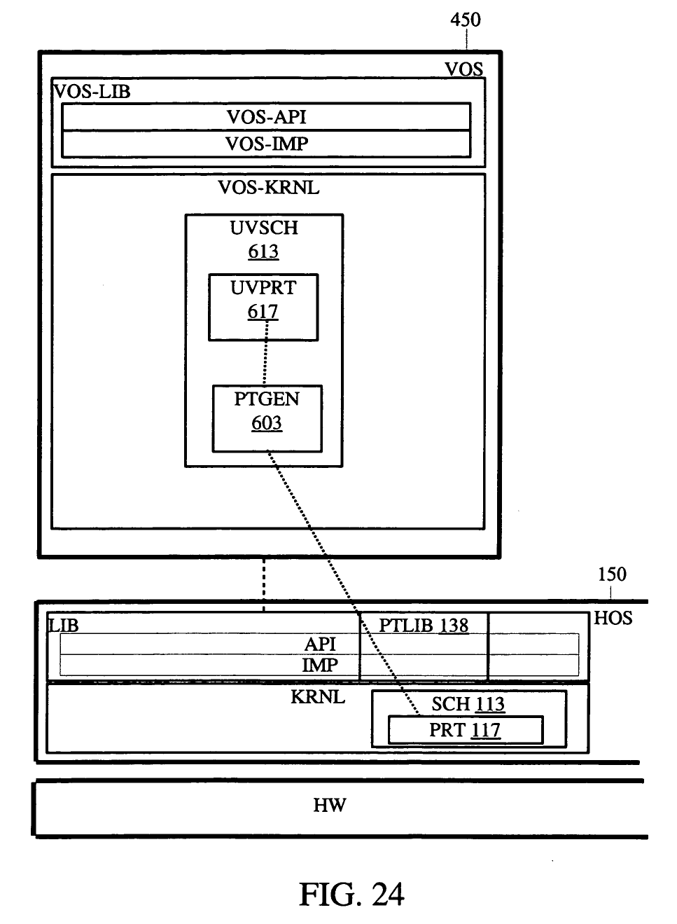

FIG. 24 depicts one embodiment of a uniform integrated process table managed by a modified scheduler. This uniform process management system includes changes to the scheduler on the virtual operating system (VOS) 450 that enable it to become a uniform virtual scheduler (UVSCH) 613. This modified scheduler is capable of integrating processes running on the host operating system (HOS) 150 into the process table of the VOS, and of giving them a uniform representation that is consistent with the representation of processes running on the VOS. Depending on the host operating system, this uniform process manager may access the host's scheduler (SCH) 113 either directly or through the host APIs (API) 130.

In one embodiment, the guest operating system is a Linux distribution which has had its process kernel code modified so that it is able to dynamically query the Windows host operating system through the dispatch library on the VOS and translate the processes running on the host into pseudo-processes on the guest. Processes in Linux are defined by a tree structure process table, in which each process has zero or more children and the root of the tree is traditionally the “init” process. Process structures are tasks, and are represented by a task_struct structure which includes information on the current process including its process identification number (PID), owner, state, flags, children and other data. In Linux 2.6, the scheduler is defined in the file “linux/sched.h.” In order to generate a uniform virtual process table (UVPRT) 617 on the virtual operating system, a pseudo process is implemented by adding an additional field, for example, called a “pseudo_process_flag” to the process definition in the “sched.h” file. A “pid_t” field called “host_id” is also added so that the kernel of the virtual operating system has access to the host processes PIDs. Note that the above configurations are described by way of examples, not by way of limitations.

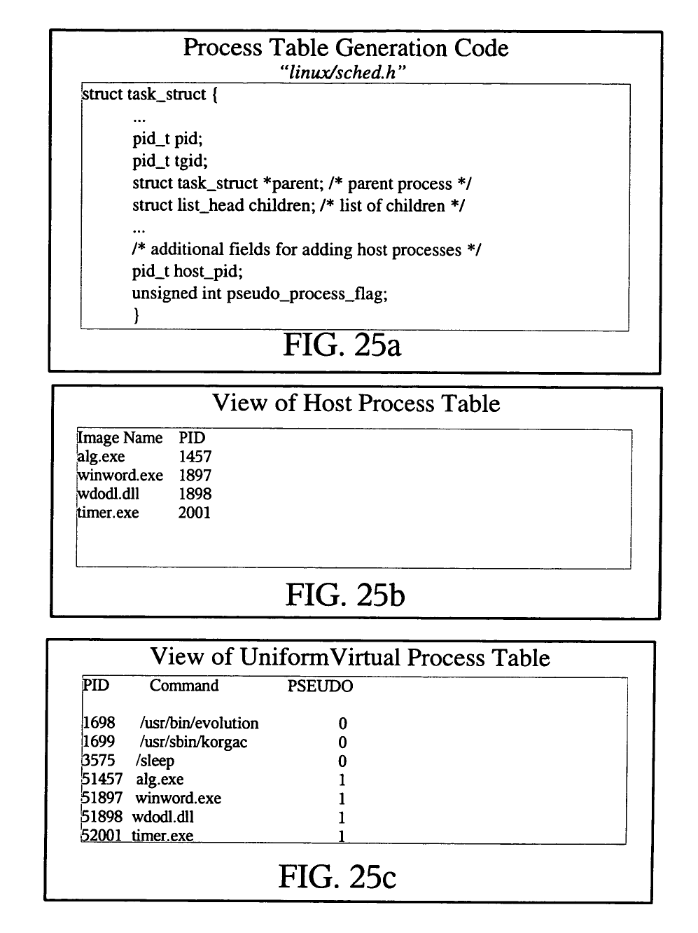

FIG. 25a depicts these changes to the “sched.h” file. FIG. 25b depicts a view of some of the fields of the process table on the host and FIG. 25c is a view of some of the fields of the integrated uniform process table. This uniform process table is generated by the process table generator (PTGEN) 603 in the uniform virtual scheduler on the guest.

To populate the virtual operating system with the processes on the host operating system, according to one embodiment, the Linux scheduler periodically makes a dispatch call to the host requesting information about host processes. Referring again to FIG. 24, in the case where the host is Windows 2000, the Linux guest uses the dispatch library to call the Windows process status helper library (PTLIB) 138. Information about each process is retrieved from the PSAPI library, including its host PID (e.g., data field “th32ProcessID), the number of threads (e.g., data field “cntThreads”) and the path to the executable (e.g., data field “szExeFile”). This information about processes on the Windows host is then returned through another dispatch call to the Linux side, where it is used by the process table generation functionality in the scheduler to generate pseudo processes on the virtual operating system that represent the host-side processes. In this way, as processes on the host are initiated and terminated, periodic updates by the scheduler update the Linux virtual process table so that these host processes are represented in a uniform manner as Linux processes, both in the kernel and in the “/proc” directory.

The processes running on the host are also differentiated from those running on the VOS by the value, for example, of the “pseudo_process_flag”. This allows the VOS to avoid scheduling the pseudo processes for execution on the VOS by having the scheduler on the virtual operating system check the flag each time it handles a process so that no pseudo processes are put into an execution queue on the VOS. It also allows the VOS to translate any operations performed by the user on the pseudo processes into corresponding operations on the real processes on the host, if the user in question has appropriate permission to do so. Any signals sent to a pseudo process may be translated to the corresponding host signal and sent to the corresponding host process. To find the corresponding host process, the PID of the process on the host operating system can be retrieved, for example, by retrieving the “host_id” field that is also stored in the pseudo process structure.

Inter-process communication may also be made uniform in order to give users and programmers full control over the way that processes interact on the host and guest operating systems, according to certain embodiments of the invention. Note that the above configurations are described by way of examples, not by way of limitations.

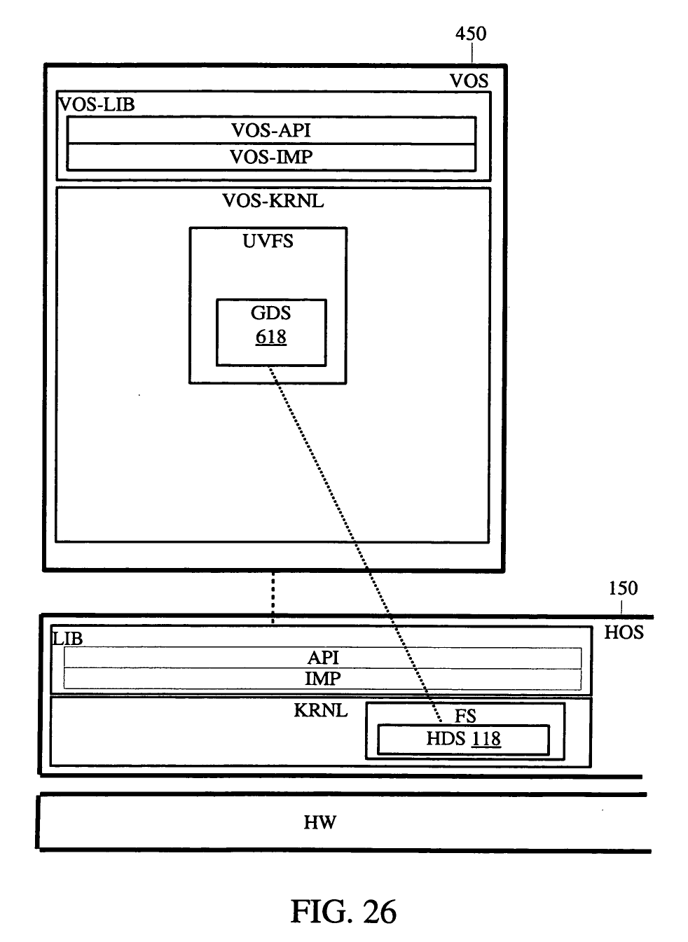

FIG. 26 illustrates one embodiment of uniform interprocess communication. This system creates a bridge interprocess structure, half of which communicates with a host process and half of which communicates with a guest process. A domain socket, which is a type of interprocess communication that uses a special file, is one method that may be used as this bridge structure. If this method is used, two domain sockets are created, one a host domain socket (HDS) 118 and one a guest domain socket (GDS) 618. In one application of such a system, the virtual operating system is Linux and the host is a FreeBSD operating system.

In one embodiment, a universal domain socket may be created by implementing two domain sockets, one on FreeBSD and one on Linux. When information is sent to the domain socket on the Linux virtual operating system it is forwarded through a simple dispatch call to the corresponding domain socket on FreeBSD where it is read by a FreeBSD process. This technique can be generalized to include other types of interprocess communication, all of which are equivalent for the purposes of this invention. In this way, the above techniques allow for the control, manipulation, and intercommunication of host processes in a uniform manner across different host operating systems.

Uniform Network Stack and Management

In one embodiment, a uniform network stack is utilized that modifies a kernel on the virtual operating system to dynamically represent network activity on the host operating system. This enables a guest operating system to uniformly represent and manage the network settings and network connections on a variety of host operating systems. This also makes it possible to write network applications for a variety of host operating systems using the resources of the virtual guest operating system.

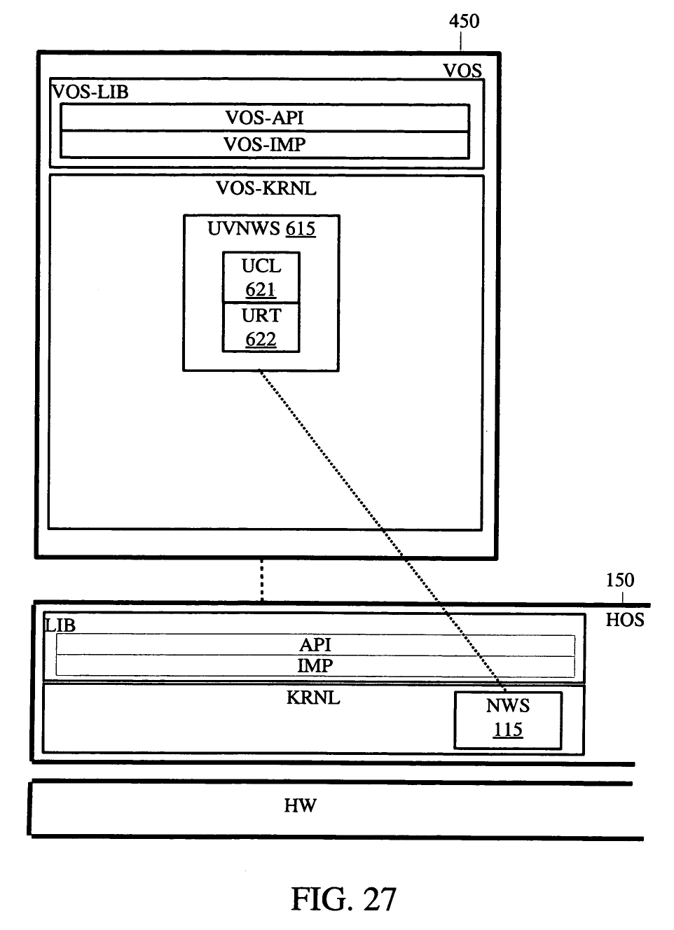

FIG. 27 depicts an embodiment of this uniform network stack and connection management system. On the guest operating system (VOS) 450, the network stack is modified to become a uniform virtual network stack (UVNWS) 615. This modified network stack dynamically reads information about network activity from the network stack (NWS) 115 in the host operating system and represents this uniformly as native network activity. Within this virtual network stack the connections of the hosts are represented as pseudo connections in the uniform connection list (UCL) 621 and the routes of the hosts are represented as pseudo routes in the uniform routing table (URT) 622.

In one embodiment, the host operating system is Linux and the guest virtual operating system is FreeBSD. The FreeBSD guest operating system dynamically reads information about host network activity and represents it as native BSD network activity via a host-side library that reads the Linux-specific files in a directory, such as “/proc/net”. These files provide information about all open network connections, as well as information on routing, device status and specific network protocols. The host library then returns this data to the FreeBSD virtual operating system through the dispatch library. In this case this is accomplished by modifying a data structure, in this case the struct “route” in the file “src/sys/net/route.h” to add a “pseudo route_flag”, and by adding a “pseudo_control_flag” to the raw interface control block in “src/sys/net/raw_cb.h”. Additional flags may also be added to the network devices and other data structures that represent networking information on the host. These flags are checked so that the guest operating system kernel is prevented from executing any code on behalf of the virtualized host network connections. This allows any system calls on the virtual operating system that affect the pseudo structures to be dispatched back to the host and a corresponding host system call to be made or emulated. Note that the above configurations are described by way of examples, not by way of limitations.

In one embodiment, low-level network software running on the guest operating system can monitor host network connections in a similar way it monitors those of the guest. For instance, a low-level monitoring library can trace the network traffic of different host operating systems using the native APIs and network abstractions of the guest operating system. In one embodiment, the virtual operating system creates a similar or identical uniform network stack representation for all possible host operating systems.

Uniform System and Application Configuration

An embodiment of the invention includes systems and methods that enable uniform virtualization of higher-level operating system features, including user and group management, application installation management and system configuration. The ability to uniformly control these higher-level operating system abstractions is a need for developers writing to the variety of operating systems that are available. While it is possible for a developer to configure these features through direct manipulation of files and processes, operating systems differ in how these higher level features are represented and administered. Each operating system would have to have platform specific code. In contrast, the uniform virtualized higher-level system resources of the preferred embodiment of the invention allow users and developers to manage all aspects of different host operating systems as if they were resources native to the guest operating system.

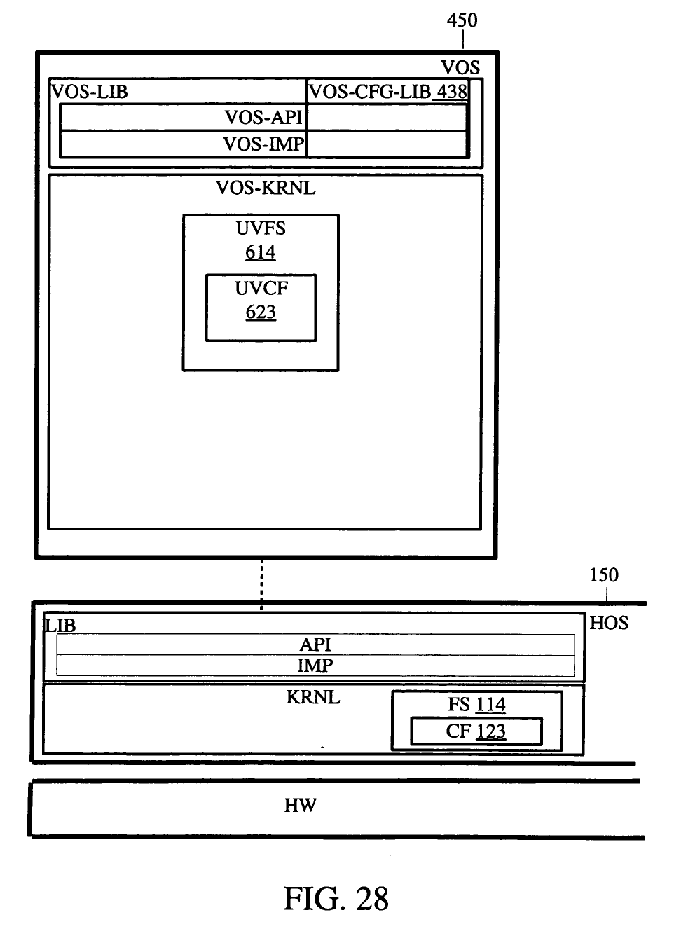

FIG. 28 presents one embodiment of this invention that has the advantage of being widely applicable. In FIG. 28, a guest operating system includes uniform representations of configuration details of the host operating system in the form of configuration files (CF) 123 that reside in the file system (FS) 114 of the guest operating system. Any changes to these files are propagated to the host via dispatch calls and any changes to the host configuration are propagated back via reverse dispatch calls. In the embodiment where the virtual operating system is Linux, when changes are made to one of these configuration files (UVCF) 623 in the file system (UVFS) 614 on the guest, a notification mechanism (e.g., inotify) may be used to notify the virtual configuration management dispatch library (VOS-CFG-LIB) 438 that changes have occurred. The library may then read those changes and communicate them to the cross platform library on the host operating system through the use of dispatch calls. The cross-platform library, in turn, can then make the corresponding changes to the configuration files or the registry of the host operating system. Likewise, when changes are made to the configuration of the host operating system, reverse dispatch calls may be used to update the guest virtual operating system.

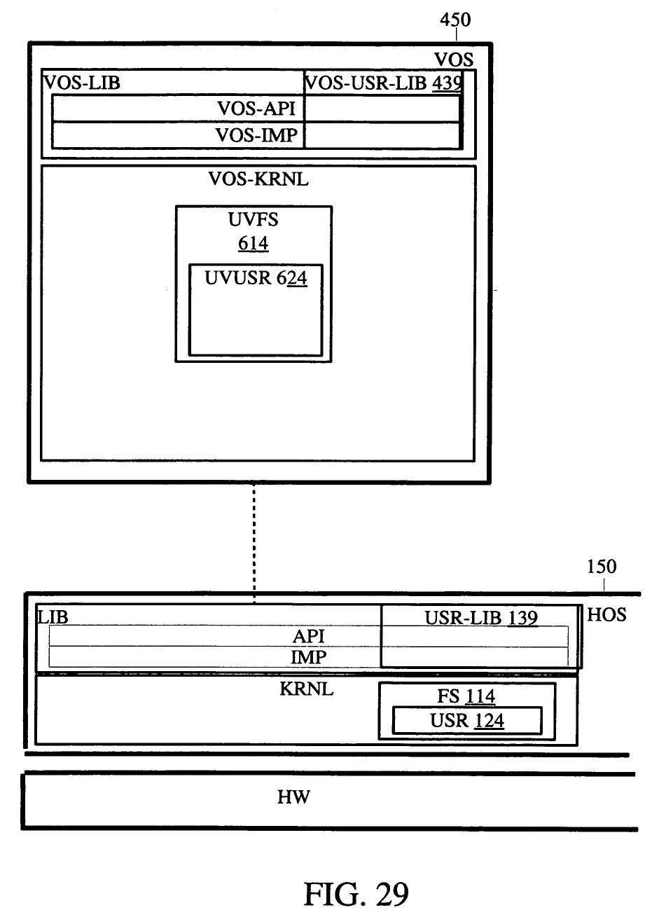

In FIG. 29, an embodiment of an integrated, uniform user and group management system is presented. There are several advantages to a uniform user and group management system, the foremost being that it enables the developer to set up and manage users and groups in a uniform manner across different host operating systems by using the native abstractions of the guest operating system. As illustrated in FIG. 29, according to one embodiment, changes to user and group settings on the guest may be forwarded to the host operating system through the same or similar dispatch library and changes to the user and group settings on the host may be sent back via reverse dispatch calls. In this embodiment, the representations on the guest operating system can be used to control the configuration details of the host and changes to the host can be instantly reflected in the uniform representations on the guest operating system. In one embodiment, these changes would only be allowed if the operations pass the limits specified by the security system.

If the guest operating system in FIG. 29 is Linux equipped with a uniform virtual file system (UVFS) 614 as described in FIG. 23, then an embodiment may make use of, for example, inotify to monitor changes in the password, shadow password and group files (UVUSR) 624 on the uniform file system. Whenever a user or application makes changes to these files, inotify informs a guest-side user management library (VOS-USR-LIB) 439 which, in turn, forwards the changes via a call to the cross-platform library on the host operating system. Upon receiving notification about the changes to the files on the guest, the cross-platform library (CP-LIB) 230 on the host then communicates with the user management library (USR-LIB) 139 of the host operating system to make an equivalent set of changes on the host. In this way, changes to user and group files on the guest are mirrored in the user and group files (USR) 124 on the file system (FS) 114 of the host. Likewise, whenever users and groups on the host are changed, these changes may be forwarded from the cross-platform library to the user management library through reverse dispatch calls and the corresponding changes made to the users and groups on the guest operating system. In all of these scenarios, if the user lacks the permissions to make the changes, they can be disallowed via the security features mentioned above.

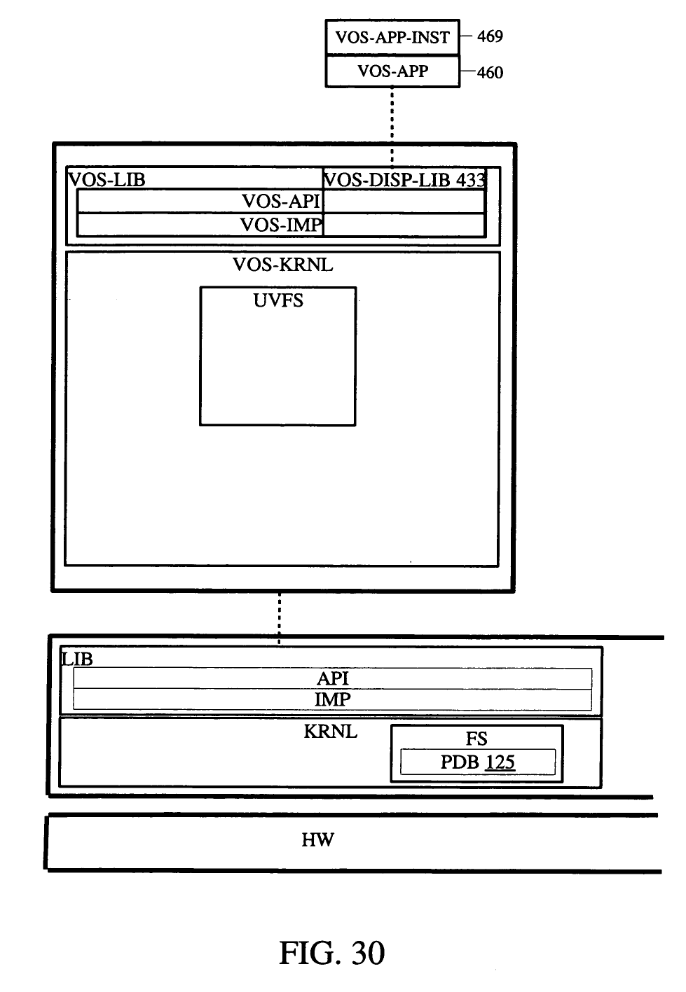

FIG. 30 is a depiction of one embodiment of such an application management system that enables users and developers to install, configure and uninstall applications on different host operating systems using a virtual operating system. In one embodiment, a Linux operating system is used as the uniform virtual operating system. In this case an installed application (VOS-APP) 460 on the Linux virtual operating system may transfer its application installation data (VOS-APP-INST) 469 to the host operating system via the dispatch library (VOS-DISP-LIB) 433. Here it is translated into a format readable by the host and stored in the host application database (PDB) 125. In this way, a single application bundle can be developed for the Linux virtual operating system and the user will be able to install it on any of the host operating system on which the invention has been implemented.

Consider this as implemented in two different host operating systems. According to one embodiment, an application installed on the virtual Linux operating system includes amongst its install files a manifest file which specifies the application's name, its description, and its configuration. This manifest file is sent via the dispatch library to the cross-platform library on the host. The host-side cross-platform library then updates the appropriate configuration data on the underlying host operating system to include install information for this application.

A Windows host, for instance, will update a registry key, such as, for example, “HKEY_LOCAL_MACHINE\Software”. A Red Hat compatible Linux host in contrast, will update its RPM database by generating a “spec” file including the application information and calling the rpm utility. This integrated application management system thus provides a uniform method of application installation management for two disparate operating systems. The same technique may be used on other operating systems to create a universal install bundle.

The key to all of these embodiments is providing a uniform representation on the guest and syncing changes to this representation with changes to the corresponding higher level feature of the host.

Uniform Ontology

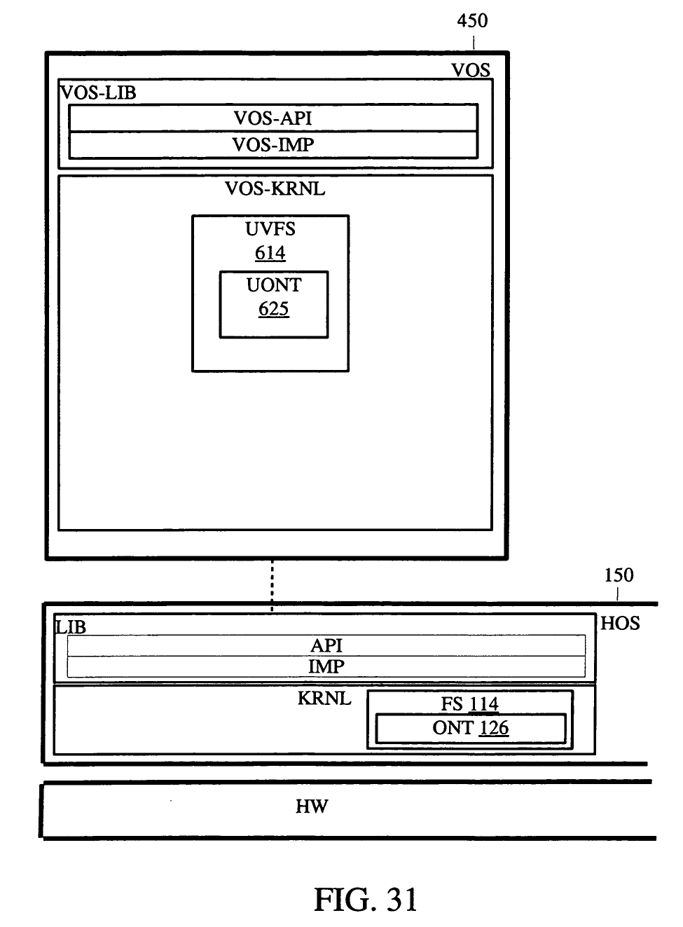

Ontological systems are coming into widespread use in operating systems. FIG. 31, is one embodiment of a system that represents the ontologies of a variety of host operating systems in a uniform manner on a virtual operating system. In this embodiment, the file system (FS) 114 of the host operating system (HOS) 150 includes a collection of ontological elements and relationships (ONT) 126 that are available to the virtual operating system (VOS) 450 by using the dispatch library (VOS-DISP-LIB) 133. The dispatch library translates the elements and relationships of the ontological relationships on the host side to uniform representations of elements and relationships on the virtual operating system. The resulting uniform ontology (UONT) 625 is then written to the file system (UVFS) 614 of the virtual operating system. In the preferred embodiment, the virtual operating system has a pre-defined preferred set of elements and relationships (e.g., DAML+OIL), and ontological information in the host is translated to extend the existing virtual operating system ontology.

Consider, for example, a host operating system using the ontological system of WinFS schemas, and a virtual operating system using RDF and RDF schemas. In one embodiment, a schema in the host ontology might look like the following:

```
Host Ontology:
<Type Name=“Address” MajorVersion=“1” MinorVersion=“0”
  ExtendsType=“Core.CategorizedNestedElement”
  ExtendsVersion=“1”>
  <Field Name=“StreetAddress”
  Type=“WinFSTypes.nvarchar(1024)”
Nullable=”true” MultiValued=“false”
  TypeMajorVersion= “1”></Field>
<Field Name=“City” Type=“WinFSTypes.nvarchar(1024)”
Nullable=“true” MultiValued=“false” TypeMajorVersion=“1”>
  </Field>
<Field Name=“State” Type=“WinFSTypes.nvarchar(1024)”
Nullable=“true” MultiValued=“false” TypeMajorVersion=
“1”><Notes></Notes>
  </Field>
<Field Name=“Zip” Type=“WinFSTypes.nvarchar(1024)”
  Nullable=“true” MultiValued=“false”
  TypeMajorVersion=“1”></Field>
</Type>
```

Using this technique, according to one embodiment, all of the addresses stored on the WinFS host system are then translated to RDF descriptions. It is assumed that the RDFS and RDF specifications have been extended to allow for data constraints, and that the resource such as “#VarString” is a variable string that cannot be greater than 1024 characters. One of the translated descriptions in this embodiment would be:

Uniform Ontology:
<rdfs:Class rdf : about=”http://www.w3c.org/2008/rdf#Address>

<rdfs: subClassOf rdf:resources =
“http://www.w3.org/2000/01/rdf-schema#Resource”/>

</rdfs:Class>
<rdf:Property rdf:ID = “StreetAddress”>

<rdfs:domain rdf:resource=”#Address”>
<rdfs:range rdf:resource=”#VarString”>

</rdf:Property>
<rdf:Property rdf:ID = “City”>

<rdfs:domain rdf:resource=”#Address”>
<rdfs:range rdf:resource=”#VarString”>

</rdf:Property>
<rdf:Property rdf:ID = “State”>

<rdfs:domain rdf:resource=”#Address”>
<rdfs:range rdf:resource=”#VarString”>

</rdf:Property>
<rdf:Property rdf:ID = “Zip”>

<rdfs:domain rdf:resource=”#Address”>
<rdfs:range rdf:resource=”#VarString”>

</rdf:Property>

To synchronize changes between the two ontologies, in one embodiment, a WinFS translator may transform WinFS types (Items, NestedTypes, ScalarTypes) to RDF classes (which support the same features) and a relationship translator may translate WinFS Relationships to RDF statements by iterating through the WinFS types using Microsoft's OPATH and generating corresponding RDF classes. The generated RDF descriptions on the virtual operating system would then provide a uniform representation of the ontology on the host operating system. Changes to the two ontologies, in turn, could be monitored and synchronized.

There are a variety of alternative methods that can be used for the purposes of illustration. In addition to the OPATH approach above, another technique is to directly generate transformation code from the XML definition of the WinFS type itself. In another embodiment, the host ontology is translated using XSLT to create the uniform ontology on the virtual operating system. In short, techniques that map one ontology to another are well explored. Instead of adding to these techniques, the invention extends the current state of the art by creating a novel uniform representation of host ontology on a cross-platform virtual operating system. This provides a cross-platform development environment in which programmers only need to write code once in order to search for text or to extract and extend ontological information from different host operating systems.

Desktop Search

Alternative embodiments of the invention may use variations of the above-described techniques to provide a cross-platform desktop search. In certain desktop search systems, files that include text that matches the search text are retrieved when a search is performed. In one embodiment, the APIs of the cross-platform library may be extended to include a cross-platform search object or function that performs an OS-specific search on the host platform, its applications and the Internet. Applications written for the virtual operating system can then transparently search the host using its native functions.

According to certain embodiments, a search may use ontological types and relationships to refine the results of the preliminary text-based search. Using ontological types and relationships allows the use of complex queries and returns only results which are relevant. In one embodiment, the cross-platform virtual operating system ontology described above may be extended with a query language such as RDQL or SPARQL. These languages and other languages like OPATH enable complex questions to be asked of the ontology. In this way, an embodiment of the invention has the capacity to deliver a cross-platform development environment in which programmers only need to write code once in order to search for information.

Cross-Platform Device Drivers

Applications that run on an operating system typically communicate with a device through the kernel of the operating system. The kernel uses a specific device driver to control the device. The device driver is typically written using a device driver library provided by the kernel and exposes APIs for manipulating the hardware of different devices. An embodiment of the invention enables an operating system to use a device even when a device driver for the given operating system does not exist.

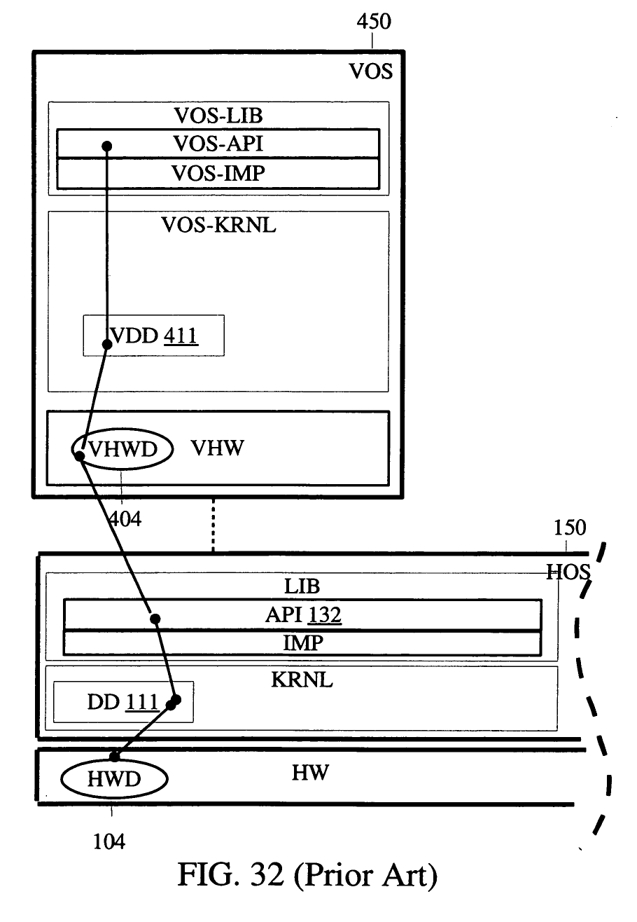

FIG. 32 depicts a conventional system and method for how a virtual device included in a virtual operating system accesses the corresponding physical device through the device drivers on the host operating system. Conventionally, instead of directly communicating with physical hardware devices (HWD) 104, virtual operating systems device drivers (VDD) 411 access the physical hardware devices through software modules known as virtual hardware devices (VHWD) 404 that are implemented to behave as if they were physical hardware devices. These virtual devices access the physical devices through host device drivers (DD) 111 by using the high-level application programming interface (API) 132 of the host operating system. For example, a guest operating system may run on emulated hardware that includes a virtual sound card. The guest operating system accesses this virtual sound card through a device driver of the guest. The virtual sound card itself runs as part of an application on the host operating system using the high-level API of the host which in turn uses the host device driver to access the physical sound card.

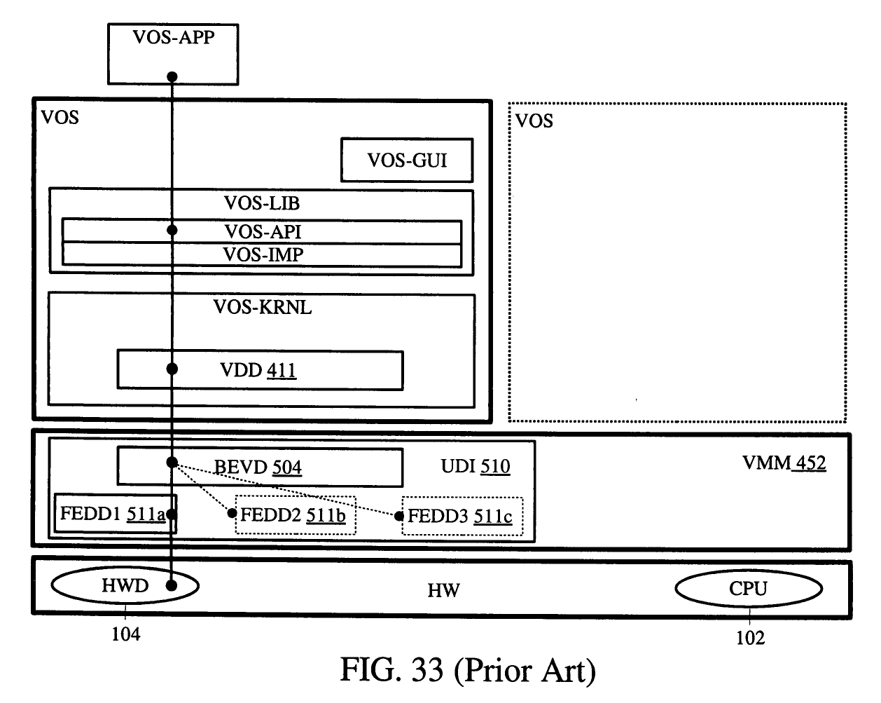

FIG. 33 depicts an alternative approach that may be implemented in systems that include a virtual machine monitor (VMM) 452 also known as a hypervisor. In this case the hypervisor includes a set of unified device interfaces (UDI) 510 in the virtual machine monitor that include a front end that interacts with a given physical hardware device (HWD) 104 and a back end exposing the virtual device included in the virtual hardware that guest operating systems run on. The front end of a unified device interface is a set of specialized device drivers (FEDD1, FEDD2, FEDD3) 511a, 511b, and 511c capable of controlling a range of physical devices in a device class.

The back end, in contrast, exposes only a single virtual device (BEVD) 504 for the entire device class and it is this generic interface that guest operating systems interact with using a virtual operating system device driver (VDD) 411. The beauty of this approach is that programmers only need to write a device driver once for the front end of a unified device interface rather than writing specific device drivers for each guest operating system.

For example, if a programmer wanted to provide guest operating systems with the ability to use a new specialized hard drive, the programmer would only have to write one device driver for the front end of the hard drive unified device interface. Assuming the guest operating systems already supported the simple virtual hard drive exported by the back end, all of the guest operating systems would then be able to use the specialized hard drive. This system works well when a hypervisor is present on the computer, but is inapplicable in a conventional setup where a hypervisor is not present.

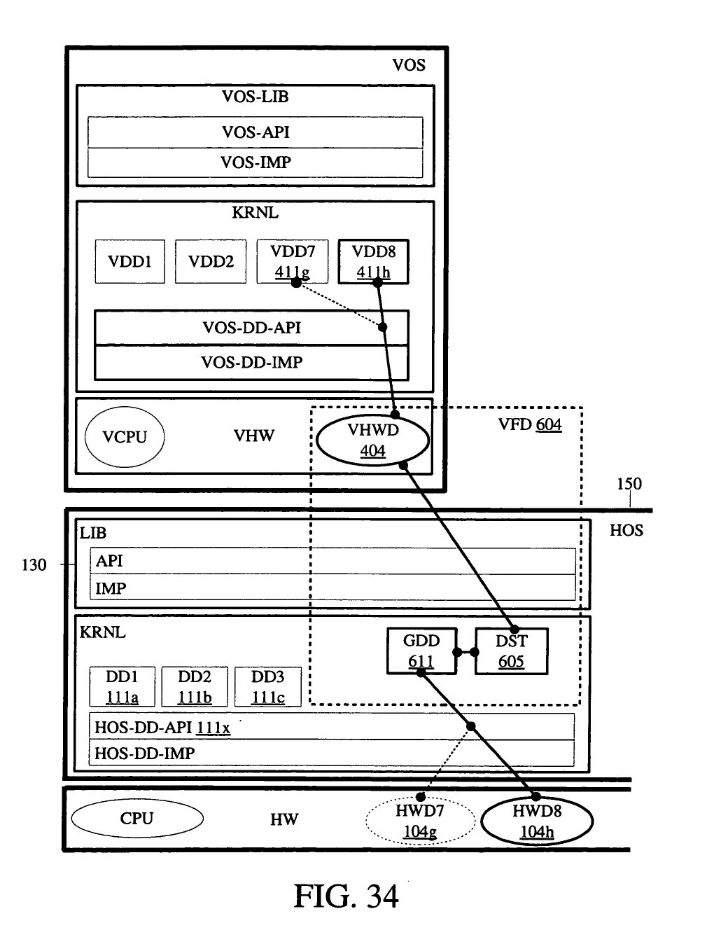

FIG. 34 depicts one embodiment of the invention for accessing hardware devices from a virtual operating system through a novel forwarding virtual device. An embodiment of the invention enables device drivers on virtual operating systems to communicate with physical hardware devices even when no appropriate device drivers exist on the host operating system and no hypervisor is present. It is independent of any specific device drivers and may provide a driver for any type of hardware device.

The configuration as shown in FIG. 34 includes a forwarding virtual device (VFD) 604. The forwarding virtual device itself is a system that includes a guest-side virtual hardware device (VHWD) 404 along with a device state translator (DST) 605 and a host-side generic device driver (GDD) 611. The device state translator synchronizes the state of the virtual hardware device with the state of the corresponding physical device that is present on the host computer. In the embodiment depicted in FIG. 34, an additional virtual device driver (VDD7) 411g is shown that could control another hardware device (HWD7) 104g if it was present in the physical hardware. This is shown in order to demonstrate that each forwarding virtual device enables a whole class of device drivers on the virtual operating system to control a corresponding class of physical devices.

In contrast to the conventional approach of simulating a hardware device that utilizes a device driver for the physical device installed on the host, according to one embodiment, a forwarding virtual device forwards input from the virtual operating system (VOS) 450 directly to the physical hardware device that is present (HWD8) 104h through the host-side generic device driver (GDD) 611 and returns output from the physical device that is present (HWD8) 104h to the virtual operating system. The generic device driver (GDD) 611 is written to the same low-level interface (HOS-DD-API) 111x of the device driver library of the host operating system kernel that the host device drivers (DD1, DD2, DD3) 111a, 111b, and 111c use. The generic device driver (GDD) is installed on the host independently of any existing device drivers.

In one embodiment, the device state translator (DST) monitors the state of the virtual device (VHWD) and forwards information about any changes to the generic device driver (GDD). The device state translator (DST) also communicates changes in the state of the physical hardware device (HWD8) 104e directly to the virtual device. When changes to the state of the physical device (HWD8) 104e are detected by the host operating system (HOS) 150, the forwarding virtual device which is listening for changes, directly updates the state of the virtual device that it includes and vice versa. This two-way communication channel effectively enables the device driver on the guest operating system to act as a host-side device driver that controls the physical device (HWD8) 104g.

In one embodiment, the virtual operating system is Linux and the host operating system is Mac OS X. The components of the forwarding device are a virtual USB device, an implementation-specific USB device driver installed on the host, and a device state translator between the two that communicates the state of the virtual USB device to the appropriate host APIs and communicates the state of the hardware USB device to the virtual operating system device. The forwarding virtual device enables a Linux USB device driver for the USB device to directly control the physical USB device through the forwarding device. Since Mac OS X is a minority operating system and Linux often supports devices that Mac OS X does not, the USB forwarding device enables any Linux USB driver to work on the Mac OS X operating system.

In this embodiment, there are three components to the USB forwarding device: the virtual device, the implementation-specific host-side USB device driver, and the device state translator. Communication between the virtual operating system and the physical hardware goes in two directions. In the direction from hardware to VOS, when the state of the hardware device is modified, the translator communicates these changes to the virtual device driver on the virtual operating system. In this case where the host operating system is Mac OS X, the host-side USB device driver within the forwarding device uses the Mac OS X IOKit to dynamically probe the physical device to retrieve its identification information.

The device state translator within the USB forwarding device proceeds to change the state of the virtual USB device by translating the received data into instructions which change the state of the virtual hardware. The Linux kernel then reads the state of the virtual USB device and passes it to the “probe” function of the relevant Linux USB device driver, allowing the device driver to register the state, in this case the identification information, of the physical device using, for example, the “usb_register_dev” function in the Linux kernel.

Similarly, according to one embodiment, changes instigated by the virtual operating system are communicated to the physical USB device. Having registered the device and loaded the appropriate device driver, the Linux device driver can send data to the device by calling certain functions, such as “usb_bulk_msg” and “usb_control_msg”. The transferred data directly affects the state of the virtual USB device. Since the device state translator is listening for a change in the virtual USB device state, it can then communicate this change in state to the physical USB device using calls to the Mac OS X IOKit through which it can directly control hardware.

For example, if data appears in the state of the virtual USB device, that data can be read from the state and written to the physical USB device using the Mac OS X APIs by creating an “IOUSBDevRequest”, setting the write buffer in “pData” and making a “DeviceRequest”. Using this system, changes communicated by the virtual operating system to the virtual device state are translated to host APIs and sent to the physical device while changes in the state of the physical device are translated from the host APIs and forwarded to the virtual device.

Through the two-way communication system offered by the forwarding device, the Linux device driver controls the physical USB device on the Macintosh operating system. In one embodiment, a graphical interface is distributed with the cross-platform device driver to ease installation. In one embodiment, this graphical interface is distributed with the cross-platform device driver as a self-contained executable that is self-extracting. In one embodiment, the system APIs of the guest operating system might be emulated in a library installed on the host. In other embodiments, the device driver library used on the host may be a cross-platform device driver library. In an alternative embodiment, instead of synchronizing the state of the two devices through inspection, the invention may forward and translate signals from the virtual operating system to the physical device and from the physical device to the virtual operating system. In an alternative embodiment, the bytecode of the guest device driver might be compiled to the host platform using dynamic compilation. In one embodiment, both of these approaches are used to increase the efficiency of the device driver. Note that a USB device has been used as an example, other devices or configurations may be applied.

An Example of a Data Processing System

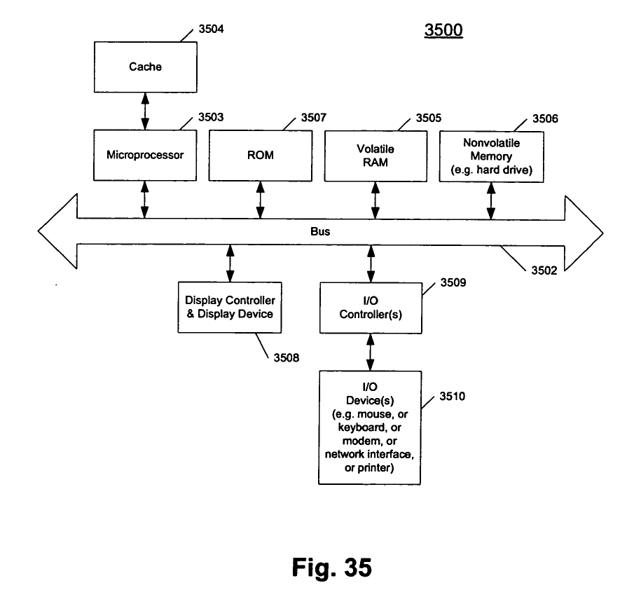

FIG. 35 is a block diagram of an example computer system that may be used with an embodiment of the invention. For example, the system 3500 shown in FIG. 35 may be configured according to any of the configurations described above. Note that while FIG. 35 illustrates various components of a computer system, it is not intended to represent any particular architecture or manner of interconnecting the components, as such details are not germane to the present invention. It will also be appreciated that network computers, handheld computers, cell phones, and other data processing systems which have fewer components or perhaps more components may also be used with the present invention. The computer system of FIG. 35 may, for example, be an Apple Macintosh computer or a IBM compatible PC.

As shown in FIG. 35, the computer system 3500, which is a form of a data processing system, includes a bus 3502 which is coupled to a microprocessor 3503 and a ROM 3507, a volatile RAM 3505, and a non-volatile memory 3506. The microprocessor 3503, which may be, for example, a PowerPC microprocessor from Motorola, Inc. or IBM or alternatively, a Pentium processor from Intel, is coupled to cache memory 3504 as shown in the example of FIG. 35. The bus 3502 interconnects these various components together and also interconnects these components 3503, 3507, 3505, and 3506 to a display controller and display device 3508, as well as to input/output (I/O) devices 3510, which may be mice, keyboards, modems, network interfaces, printers, and other devices which are well-known in the art.

Typically, the input/output devices 3510 are coupled to the system through input/output controllers 3509. The volatile RAM 3505 is typically implemented as dynamic RAM (DRAM) which requires power continuously in order to refresh or maintain the data in the memory. The non-volatile memory 3506 is typically a magnetic hard drive, a magnetic optical drive, an optical drive, or a DVD RAM or other type of memory system which maintains data even after power is removed from the system. Typically the non-volatile memory will also be a random access memory, although this is not required.

While FIG. 35 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 3502 may include one or more buses connected to each other through various bridges, controllers, and/or adapters, as is well-known in the art. In one embodiment, the I/O controller 3509 includes a USB (Universal Serial Bus) adapter for controlling USB peripherals. Alternatively, I/O controller 3509 may include an IEEE-1394 adapter, also known as FireWire adapter, for controlling FireWire devices.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

A machine-readable medium may include any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. An apparatus comprising:
a first operating system with a first operating system kernel and a first operating system resource;
a second operating system with a second operating system kernel and a second operating system resource; and
a resource translator to create a uniform representation of the first and second operating system resources as at least one operating system resource in a third operating system.

2. A apparatus comprising:
a virtual operating system (VOS) including a VOS kernel;
a host operating system (HOS) including a HOS kernel;
a resource translator to create a uniform representation on the VOS of a given operating system resource from the HOS.

3. The apparatus of claim 2, further comprising:
a set of files and directories comprising a virtual file system on the VOS;
a set of files and directories comprising a file system on the HOS, wherein the resource translator determines a location of files and directories on the HOS and creates a uniform representation of the files and directories on the VOS.

4. The apparatus of claim 2, further comprising:
a process communication channel on the HOS,
wherein the resource translator represents the process communication channel in a uniform manner on the VOS.

5. The apparatus of claim 2, further comprising:
a network stack on the HOS,
wherein the resource translator represents the network stack in a uniform manner on the VOS.

6. The apparatus of claim 2, further comprising:
a set of processes on the HOS,
wherein the resource translator represents the processes in a uniform manner on the VOS.

7. The apparatus of claim 2, further comprising:
a set of users on the HOS; and
a set of groups on the HOS,
wherein the resource translator represents the users and groups in a uniform manner on the VOS.

8. The apparatus of claim 2, further comprising:
a record containing information about applications on the HOS,
wherein the resource translator represents the information in a uniform manner on the VOS.

9. The apparatus of claim 2, further comprising:
a set of configuration files on the HOS,
wherein the resource translator represents the configuration files in a uniform manner on the VOS.

10. The apparatus of claim 2, further comprising:
an ontological collection of elements and relationships on the HOS,
wherein the resource translator represents the ontological collection in a uniform manner on the VOS;

11. A method in which a virtual operating system (VOS) represents a host operating system (HOS) resource, the method comprising:
establishing a communication channel between a VOS kernel of the VOS and a HOS kernel of the HOS;
sending a query about a host resource from the VOS kernel to the HOS kernel via the communication channel;
receiving the query in the HOS kernel and sending the requested information back to the VOS kernel via the communication channel; and
translating within the VOS the received information into a uniform representation of the host resource.

12. The method of claim 11, wherein changes to a native representation residing on the VOS are propagated back to the HOS using the communication channel.

13. The method of claim 11, wherein the HOS resource comprises a file system.

14. The method of claim 11, wherein the HOS resource comprises a process communication channel.

15. The method of claim 11, wherein the HOS resource comprises a network stack.

16. The method of claim 11, wherein the HOS resource comprises a set of processes.

17. The method of claim 11, wherein the HOS resource comprises a set of users and groups.

18. The method of claim 11, wherein the HOS resource comprises a record containing information about applications on the HOS.

19. The method of claim 11, wherein the HOS resource comprises a set of configuration files on the HOS.

20. The method of claim 11, wherein the HOS resource comprises an ontological collection of elements and relationships on the HOS.
